(19) United States
(12) Patent Application Publication
(10) Pub. No.: US 2025/0358695 A1
(43) Pub. Date: Nov. 20, 2025

(54) CENTRAL UNIT, DISTRIBUTED UNIT, RADIO ACCESS NETWORK NODE, UE, AND METHODS THEREFOR

(71) Applicant: NEC CORPORATION, Minato-ku, Tokyo (JP)

(72) Inventors: Hisashi FUTAKI, Tokyo (JP); Sadafuku HAYASHI, Tokyo (JP)

(73) Assignee: NEC CORPORATION, Minato-ku, Tokyo (JP)

(21) Appl. No.: 18/868,266

(22) PCT Filed: Jul. 7, 2023
(86) PCT No.: PCT/JP2023/025349

§ 371 Date: Nov. 22, 2024

(30) Foreign Application Priority Data
Jul. 29, 2022 (JP) 2022-121937

(51) Int. Cl. H04W 36/04; H04W 16/28; H04W 74/0833; H04W 76/30

(52) U.S. Cl. CPC H04W 36/04; H04W 16/28; H04W 74/0833; H04W 76/30

(57) ABSTRACT

A central unit (CU) (301) receives from a first distributed unit (DU) (302) a first message related to preparation for Layer-1 or Layer-2 (L1/L2) based inter-cell mobility of a UE. The L1/L2-based inter-cell mobility is intra-DU L1/L2-based inter-cell mobility within the first DU (302) or inter-DU L1/L2-based inter-cell mobility from the first DU (302) to a second DU. After receiving the first message, the CU (301) sends to the first DU (302) a second message related to the preparation for the L1/L2-based inter-cell mobility. This helps, for example, to enable the source distributed unit (DU) and the central unit (CU) to prepare for L1/L2 based inter-cell mobility.

### TECHNICAL FIELD

The present disclosure relates to radio communication systems, and in particular to mobility of a User Equipment (UE).

### BACKGROUND ART

The 3rd Generation Partnership Project (3GPP (registered trademark)) Release 15 and later releases specify network control mobility applicable to UEs in RRC_CONNECTED, including cell-level mobility and beam-level mobility (see, for example, Section 9.2.3 of Non-Patent Literature 1). Cell-level mobility requires explicit Radio Resource Control (RRC) signaling to be triggered, i.e., it requires handover. Existing cell-level mobility may be referred to as Layer-3 (L3)-based cell-level mobility, L3-based inter-cell mobility, or L3-based handover, to distinguish it from Layer-1/Layer-2 (L1/L2)-based inter-cell mobility. Cell-level mobility includes intra-gNB Central Unit (CU) mobility or handover. Intra-gNB-CU mobility or handover includes intra-gNB Distributed Unit (DU) mobility or handover, and inter-gNB-DU mobility or handover. In addition, cell-level mobility may include Master Cell Group (MCG) Primary Cell (PCell) change and Secondary Cell Group (SCG) Primary SCG Cell (PSCell) change in dual connectivity.

Beam-level mobility, on the other hand, does not require explicit RRC signaling to be triggered. In 3GPP Release 17, beam-level mobility can be intra-cell or inter-cell. The former is referred to as intra-cell beam-level mobility and the latter as inter-cell beam-level mobility. Inter-cell beam-level mobility is also referred to as inter-cell beam management (ICBM). In the case of ICBM, the UE can receive or transmit UE dedicated channels/signals via a Transmission Reception Point (TRP) associated with a different Physical Cell Identity (PCI) than the PCI of the serving cell, while non-UE dedicated channels/signals can only be received via a TRP associated with the PCI of the serving cell. The gNB provides the UE with a measurement configuration via RRC signaling. The measurement configuration includes a configuration of Synchronization Signal (SS)/Physical Broadcast Channel (PBCH) block (SSB) and/or Channel State Information (CSI) Reference Signal (CSI-RS) resources and resource sets. In the case of ICBM, the measurement configuration includes SSB resources associated with a different PCI than the PCI of the serving cell. Beam-level mobility is handled at the lower layers by control signaling at the Physical (PHY) and Medium Access Control (MAC) layers. As a result, the RRC does not need to know which beam is in use at any given time. As can be seen from the above description, inter-cell beam-level mobility or inter-cell beam management (ICBM) applied to a UE in RRC_CONNECTED is clearly distinguished from cell-level mobility or handover in that it does not involve a change in the serving cell of the UE.

3GPP Release 16 and later releases specify multiple TRP (multi-TRP) operation (see, for example, Non-Patent Literature 1 and 2). Multi-TRP operation is also referred to as multi-TRP transmission. Multi-TRP operation is one of the beam management techniques specified in the 3GPP specification. Multi-TRP operation includes Non-Coherent Joint Transmission (NCJT) of a Physical Downlink Shared Channel (PDSCH) from multiple TRPs to a single UE. In NCJT, cooperating TRPs can transmit independent layers (or data streams) to the UE. In NCJT, each TRP transmits a different Multiple Input Multiple Output (MIMO) layer, so the requirements for synchronization and CSI accuracy are relatively low. Unlike other Coordinated Multipoint (CoMP) technologies, NCJT requires little data exchange between TRPs. The NCJT operation handles each of the transmissions from the TRPs to the UE individually. That is, scheduling, rank and precoding matrix selection, and Modulation and Coding Scheme (MCS) selection can be done separately for each TRP.

There are two design approaches for multi-TRP PDSCH transmission, one is single Physical Downlink Control Channel (PDCCH)-based multi-TRP transmission and the other is multi-PDCCH-based multi-TRP transmission. In the case of single PDCCH-based multi-TRP transmission, a single Downlink Control Information (DCI) transmitted on a single PDCCH schedules a single multilayer PDSCH in which different PDSCH layers are transmitted from different transmission points. In other words, in single PDCCH-based multi-TRP transmission, a single PDSCH associated with a single transport block is transmitted over multiple TRPs. In contrast, in the case of multi-PDCCH-based multi-TRP transmission, PDCCHs from different TRPs schedule their respective PDSCHs. In other words, in multi-PDCCH-based multi-TRP transmission, there is a single PDSCH and associated transport block transmitted from each transmission point, and individual DCIs carried by individual PDCCHs schedule their respective PDSCHs.

In addition to the multi-TRP PDSCH transmission described above, 3GPP Release 17 supports multi-TRP PDCCH repetition, multi-TRP Physical Uplink Shared Channel (PUSCH) repetition, and multi-TRP Physical Uplink Control Channel (PUCCH) repetition (see, for example, Non-Patent Literature 1 to 4).

3GPP Release 17 further specifies enhancements related to Quasi-Colocation (QCL) and Transmission Configuration Indicator (TCI) to support inter-cell operation for multi-TRP PDSCH transmission (see, for example, Non-Patent Literature 1 to 4). Inter-cell multi-TRP operation assumes multi-PDCCH based multi-TRP PDSCH transmission. The UE can be configured with an SSB associated with a different PCI (i.e., an additional PCI) than the serving cell PCI. The UE can be configured with up to seven additional PCIs, only one of which is activated in the case of inter-cell multi-TRP operation. An additional PCI can be associated with one or more TCI states. The gNB can dynamically schedule a PDSCH from any TRP by dynamically indicating a TCI state in a DCI.

3GPP will discuss L1/L2 mobility enhancements for 3GPP Release 18 (see, for example, Non-Patent Literature 5). When a UE moves from the coverage area of one cell to another, a serving cell change needs to be performed at some point. Currently, the serving cell change is triggered by an L3 measurement and is performed by a reconfiguration with synchronization triggered by RRC signaling for PCell and PSCell change, and involves the release and addition of Secondary Cells (SCells), if applicable. In all cases, a complete reset of L2 (and L1) is performed, resulting in longer latency, higher overhead, and longer interruption time compared to beam-switched mobility (or beam-level mobility). The goal of L1/L2 mobility enhancement is to enable a serving cell change through L1/L2 signaling to reduce latency, overhead, and interruption time. L1/L2 signaling refers to either or both L1 signaling and L2 signaling.

One of the detailed objectives of the L1/L2 mobility enhancement work item is to specify mechanisms and procedures for L1/L2-based inter-cell mobility for latency reduction. These include:
Configuration and maintenance for multiple candidate cells to allow fast application of configurations for candidate cells;
Dynamic switch mechanism among candidate serving cells (including Special Cell (SpCell) and SCell) for the potential applicable scenarios based on L1/L2 signalling;
L1 enhancements for inter-cell beam management, including L1 measurement and reporting, and beam indication;
Timing Advance management;
CU-DU interface signaling to support L1/L2 mobility, if needed.

The L1/L2-based inter-cell mobility procedures are applicable to the following scenarios:
Standalone, Carrier Aggregation, and NR Dual Connectivity (NR-DC) cases where the serving cell is changed within a single Cell Group (CG);
Intra-DU case and intra-CU inter-DU case (applicable for Standalone and CA: no new Radio Access Network (RAN) interfaces are expected);
Both intra-frequency and inter-frequency;
Both FR1 (i.e., sub-6 GHz band) and FR2 (i.e., millimeter wave (mmWave) band);
Source and target cells may be synchronized or non-synchronized.

Patent Literature 1 discloses L1/L2-based inter-cell mobility or similar technologies. In particular, FIG. 2 and paragraph [0078] of Patent Literature 1 describe a case (i.e., Case 2) in which the UE changes the serving cell between two TRPs within a single DU. This is referred to as L2 intra-DU Mobility Management (MM). Meanwhile, FIG. 2 and paragraph [0079] of Patent Literature 1 describe a case (i.e., Case 3) where the UE changes the serving cell between two TRPs between different DUs. This is referred to as L2 inter-DU MM. As shown in paragraph [0082] and Table 1 of Patent Literature 1, these two cases can be referred to as intra-CU intra-DU (inter-TRP) inter-cell L2 mobility and intra-CU inter-DU (inter-TRP) inter-cell L2 mobility, respectively.

FIG. 3, FIG. 4, FIG. 5, and paragraphs [0083]-[0099] of Patent Literature 1 provide specific examples of L2 mobility for the two cases above. These provide L2 mobility that utilizes L1 or L2 signaling while reducing or avoiding L3 signaling, including L3 RRC signaling.

The L2 signaling in Patent Literature 1 is signaling between a DU and its TRPs, between a DU and a UE, between DUs, or between TRPs. Such L2 signaling partially or fully replaces the L3 RRC signaling between a CU and a UE. The L2 signaling includes MAC Control Elements (CEs), DCI for a PDCCH, Uplink Control Information (UCI) for a PUCCH or a PUSCH, other MAC layer messages mapped from RRC messages of light weight or simplified content, and other signaling that offers similar RRC functionality at a MAC, Packet Data Convergence Protocol (PDCP), Radio Link Control (RLC), or another layer below an RRC layer. The function of the L2 signaling may be similar to L3 measurement reports, mobility configuration, handover commands, another L3 signaling, but may be more concise, simpler, or faster for control turn-around. DUs generate the L2 signaling based on dynamic RRC or static system configurations from a CU, statically programmed policies or parameters, localized Uplink (UL) measurement from TRPs, Downlink (DL) measurement reports from a UE to the TRPs in the UL, or localized DL measurement reports from the UE.

FIG. 3 and paragraphs [0084]-[0090] of Patent Literature 1 show L2 mobility using L3 DL mobility as a foundation. In step 325 of FIG. 3 of Patent Literature 1, the UE, the source DU, the target DU, and the CU perform pre-configuration for L2 mobility. The pre-configuration includes dynamic L3 RRC signaling, dynamic L2 signaling, dynamic selection of the mobility scheme, or statically programmed policies or parameters.

In step 335 of FIG. 3 of Patent Literature 1, an L2 trigger for an inter-DU handover occurs in the UE. In step 340 of FIG. 3 of Patent Literature 1, the UE transmits an L2 measurement report to the source DU. The L2 measurement report includes a MAC CE, UCI, or RLC status. In step 345 of FIG. 3 of Patent Literature 1, the source DU and the target DU perform an L2 handover decision with messages over a direct interface. Alternatively, the source DU learns of the target DU or vice versa through the CU. The L2 handover decision may include an admission control decision made by the target DU.

In step 350 of FIG. 3 of Patent Literature 1, the source DU performs an RLC reset. This occurs when the source DU and the target DU agree on the L2 handover decision. In step 355 of FIG. 3 of Patent Literature 1, the source DU and the CU perform an L2 data and context transfer. The source DU may initiate the L2 data and context transfer because it learns of the L2 handover decision earlier than the target DU in order to notify the CU about the L2 handover decision. The CU remains the same after the handover and thus a PDCP anchor at the CU stays the same, a security context and a PDN bearer also stay the same. Accordingly, only RLC layer and below contexts may be exchanged between the source DU and the target DU. Step 355 may also include an explicit handover request from the source DU to the CU and then a handover response from the CU to the source DU, or vice versa.

In step 360 of FIG. 3 of Patent Literature 1, the target DU and the CU perform forwarding or redirecting of buffered packets to the target DU and perform a context redirect similar to the process at step 355. Step 360 may use a PDCP split bearer similar to that in Long Term Evolution (LTE) dual connectivity or may use another feasible bearer.

In step 365 of FIG. 3 of Patent Literature 1, the target DU transmits an L2 handover command to the UE using L1 or L2 signaling, such as MAC CE, DCI, or UCI, rather than using L3 RRC signaling. The L2 handover command includes an RLC renewal, a target cell identifier, an L2 context, a pre-assigned preamble for RACH, or other information. The L2 handover command may be an L1 message or an L2 message converted from an RRC-level command, or an L1 or L2 encapsulation of the L3 RRC message. Alternatively, the target DU transmits a handover request to the UE and the UE transmits a response to the target DU, or vice versa. Alternatively, the source DU transmits to the UE the L2 handover command or request, which the UE acknowledges. In step 370 of FIG. 3 of Patent Literature 1, the UE performs a context update.

In step 375 of FIG. 3 of Patent Literature 1, the UE and the target DU, or the UE and the TRP associated with the target DU, start the handover process by performing a Random Access Channel (RACH) synchronization. This RACH synchronization may be a two-step RACH synchronization. The two-step RACH synchronization implies that no L3 RRC handshake is needed. Alternatively, the RACH synchronization is a four-step RACH synchronization involving RRC-level signaling with the CU. Step 375 includes steps 380 and 385. In step 385, the target DU transmits a Random Access Response (RAR) to the UE. The RAR includes a new L2 context and may also include other information. Finally, in step 390, the UE, the target DU, and the CU perform a data path renewal. The UE, the target DU, and the CU may also perform a control path renewal.

### CITATION LIST

### Patent Literature

[Patent Literature 1] US 2018/0279182 A1

### Non Patent Literature

[Non-Patent Literature 1] 3GPP TS 38.300 V17.0.0 (2022-03), “3rd Generation Partnership Project; Technical Specification Group Radio Access Network; NR; NR and NG-RAN Overall Description; Stage 2 (Release 17)”, April 2022

[Non-Patent Literature 2] 3GPP TS 38.331 V17.0.0 (2022-03), “3rd Generation Partnership Project; Technical Specification Group Radio Access Network; NR; Radio Resource Control (RRC) protocol specification (Release 17)”, April 2022

[Non-Patent Literature 3] Samsung, “WI summary for WI Core part: Further enhancements on MIMO for NR”, RP-220802, 3GPP TSG-RAN Meeting #95-e, Mar. 17-23, 2022

[Non-Patent Literature 4] Ericsson, “Correction for feMIMO WI”, R2-2206881, 3GPP TSG-RAN WG2 Meeting #118-e, May 9-20, 2022

[Non-Patent Literature 5] MediaTek Inc., “Revised WID on Further NR mobility enhancements”, RP-221799, 3GPP TSG-RAN Meeting #96, Budapest, Hungary, Jun. 6-9, 2022

### SUMMARY OF INVENTION

### Technical Problem

First, the definition or meaning of the term “L1/L2-based inter-cell mobility” as used herein is explained. At present, it is not entirely clear what L1/L2-based inter-cell mobility of 3GPP Release 18 specifically means. However, based on the current discussions, L1/L2-based inter-cell mobility can be considered as one of the network-controlled mobilities applicable to a UE in RRC_CONNECTED and involves a serving cell change for a UE.

Note that L1/L2-based inter-cell mobility does not completely preclude the use of L3 (RRC) signaling. For example, the UE needs to be provided by the gNB (e.g., gNB-CU) with RRC configurations (e.g., serving cell configuration, cell group configuration) for a new serving cell (i.e., target cell). At least part of the RRC configurations of the new serving or target cell may be provided to the UE via L3 (or RRC) signaling prior to the execution of L1/L2-based inter-cell mobility. In this case, the UE may maintain the configurations of the current and new serving cells and switch between the two configurations in response to a decision or indication to perform L1/L2-based inter-cell mobility. Alternatively, at least part of the RRC configurations of the new serving or target cell may be provided to the UE via L3 (or RRC) signaling after the execution of L1/L2-based inter-cell mobility.

L1/L2-based inter-cell mobility may be used for a PCell or MCG change for dual connectivity and a PSCell or SCG change for dual connectivity.

L1/L2-based inter-cell mobility may be referred to as L1/L2-based cell-level mobility, L1/L2-based handover, L1/L2-based PSCell change, or L1/L2-based Reconfiguration with sync. L1/L2-based inter-cell mobility may be referred to as L2-based inter-cell mobility, L2-based cell-level mobility, L2-based handover, L2-based PSCell change, or L2-based Reconfiguration with sync.

The inventors have studied L1/L2-based inter-cell mobility and found problems. One of these problems relates to the preparation (or pre-configuration) for L1/L2-based inter-cell mobility. Currently, it is not clear in which procedure or step the preparation (or pre-configuration) for L1/L2-based inter-cell mobility is performed. Patent Literature 1 describes, for example, in step 325 of FIG. 3, step 413 of FIG. 4, paragraphs [0085], [0092] and [0107] that pre-configuration for L2-based inter-DU inter-cell mobility is performed. The pre-configuration includes dynamic L3 RRC signaling, dynamic L2 signaling, dynamic selection of the mobility scheme, or statically programmed policies or parameters. However, Patent Literature 1 does not explicitly state how signaling occurs between the CU, the source DU, and the target DU during the pre-configuration step.

Another problem relates to improving the reliability of L1/L2-based inter-cell mobility. The specific procedures for L1/L2-based inter-cell mobility are not yet clear, but in some implementations, L1 or L2 signaling may be used to convey a serving cell change decision, request, or indication from the (source) DU to the UE or vice versa. To increase the reachability of this L1 or L2 signaling, it may be useful to prepare in advance the state in which this signaling is transmitted or received via the target TRP serving the target cell. To accomplish this, it may be useful to use existing multi-TRP operation or extensions thereof in combination with L1/L2-based inter-cell mobility. Patent Literature 1 states in step 360 of FIG. 3 and paragraph that a PDCP split bearer in dual connectivity may be used to forward or redirect buffered packets from the CU to the target DU. However, Patent Literature 1 does not describe the use of multi-TRP operation during or prior to L1/L2-based inter-cell mobility.

Another problem relates to inter-DU L1/L2-based inter-cell mobility. Current 3GPP discussions have not yet clarified the procedures for inter-DU L1/L2-based inter-cell mobility. As mentioned above, FIGS. 3 to 5 and the related paragraphs of Patent Literature 1 disclose multiple procedures for L2-based inter-DU inter-cell mobility. However, steps not included in the procedures disclosed in Patent Literature 1 may be required.

Another problem relates to the internal behavior of the UE. Current 3GPP discussions have not yet clarified the internal behavior of the UE in L1/L2-based inter-cell mobility. Patent Literature 1 does not specifically disclose the internal behavior of the UE, in particular what interactions take place between the RRC layer and the lower layers (e.g., MAC and PHY layers).

One of the objects to be achieved by the example embodiments disclosed herein seek to achieve is to provide apparatuses, methods, and programs that contribute to solving at least one of a plurality of problems, including the problems described above. It should be noted that this object is only one of the objects to be achieved by the example embodiments disclosed herein. Other objects or problems and novel features will become apparent from the following description and the accompanying drawings.

### Solution to Problem

A first aspect is directed to a central unit (CU) of a radio access network node. The CU includes at least one memory and at least one processor coupled to the at least one memory. The at least one processor is configured to receive from a first distributed unit (DU) of the radio access network node a first message related to preparation for L1/L2-based inter-cell mobility of a UE. The L1/L2-based inter-cell mobility is intra-DU L1/L2-based inter-cell mobility within the first DU or inter-DU L1/L2-based inter-cell mobility from the first DU to a second DU. The at least one processor is configured to, after receiving the first message, send to the first DU a second message related to the preparation for the L1/L2-based inter-cell mobility.

A second aspect is directed to a method performed by a CU of a radio access network node. The method includes the steps of:

(a) receiving from a first DU of the radio access network node a first message related to preparation for L1/L2-based inter-cell mobility of a UE, wherein the L1/L2-based inter-cell mobility is intra-DU L1/L2-based inter-cell mobility within the first DU or inter-DU L1/L2-based inter-cell mobility from the first DU to a second DU; and
(b) after receiving the first message, sending to the first DU a second message related to the preparation for the L1/L2-based inter-cell mobility.

A third aspect is directed to a first DU of a radio access network node. The first DU includes at least one memory and at least one processor coupled to the at least one memory. The at least one processor is configured to send to a CU of the radio access network node a first message related to preparation for L1/L2-based inter-cell mobility of a UE. The L1/L2-based inter-cell mobility is intra-DU L1/L2-based inter-cell mobility within the first DU or inter-DU L1/L2-based inter-cell mobility from the first DU to a second DU. The at least one processor is configured to, after sending the first message, receive from the CU a second message related to the preparation for the L1/L2-based inter-cell mobility.

A fourth aspect is directed to a method performed by a first DU of a radio access network node. The method includes the steps of:

(a) sending to a CU of the radio access network node a first message related to preparation for L1/L2-based inter-cell mobility of a UE, wherein the L1/L2-based inter-cell mobility is intra-DU L1/L2-based inter-cell mobility within the first DU or inter-DU L1/L2-based inter-cell mobility from the first DU to a second DU; and
(b) after sending the first message, receiving from the CU a second message related to the preparation for the L1/L2-based inter-cell mobility.

A fifth aspect is directed to a second DU of a radio access network node. The second DU includes at least one memory and at least one processor coupled to the at least one memory. The at least one processor is configured to receive from a CU of the radio access network node a third message related to preparation for L1/L2-based inter-cell mobility of a UE. The L1/L2-based inter-cell mobility is inter-DU L1/L2-based inter-cell mobility from a first DU to the second DU. The at least one processor is configured to, after receiving the third message, send to the CU a fourth message related to the preparation for the L1/L2-based inter-cell mobility.

A sixth aspect is directed to a method performed by a second DU of a radio access network node. The method includes the steps of:

(a) receiving from a CU of the radio access network node a third message related to preparation for L1/L2-based inter-cell mobility of a UE, wherein the L1/L2-based inter-cell mobility is inter-DU L1/L2-based inter-cell mobility from a first DU to the second DU; and
(b) after receiving the third message, sending to the CU a fourth message related to the preparation for the L1/L2-based inter-cell mobility.

A seventh aspect is directed to a radio access network node. The radio access network node includes at least one memory and at least one processor coupled to the at least one memory. The at least one processor is configured to communicate with a UE via a source TRP serving a source cell. The at least one processor is further configured to, during or prior to execution of L1/L2-based inter-cell mobility for changing a serving cell of the UE from the source cell to a target cell provided by a target TRP, perform a multi-TRP operation between the source TRP and the target TRP. The L1/L2-based inter-cell mobility is intra-DU L1/L2-based inter-cell mobility within a first DU or inter-DU L1/L2-based inter-cell mobility from the first DU to a second DU.

An eighth aspect is directed to a method performed by a radio access network node. The method includes the steps of:

(a) communicating with a UE via a source TRP serving a source cell; and
(b) during or prior to execution of L1/L2-based inter-cell mobility for changing a serving cell of the UE from the source cell to a target cell provided by a target TRP, performing a multi-TRP operation between the source TRP and the target TRP, wherein the L1/L2-based inter-cell mobility is intra-DU L1/L2-based inter-cell mobility within a first DU or inter-DU L1/L2-based inter-cell mobility from the first DU to a second DU.

A ninth aspect is directed to a second DU of a radio access network node. The second DU includes at least one memory and at least one processor coupled to the at least one memory. The at least one processor is configured to, during or prior to execution of inter-DU L1/L2-based inter-cell mobility from a source cell associated with a first DU to a target cell associated with the second DU, control a target TRP to perform a multi-TRP operation between a source TRP serving the serving cell and the target TRP serving the target cell.

A tenth aspect is directed to a method performed by a second DU of a radio access network node. The method includes, during or prior to execution of inter-DU L1/L2-based inter-cell mobility from a source cell associated with a first DU to a target cell associated with the second DU, controlling a target TRP to perform a multi-TRP operation between a source TRP serving the serving cell and the target TRP serving the target cell.

An eleventh aspect is directed to a UE. The UE includes at least one memory and at least one processor coupled to the at least one memory. The at least one processor is configured to communicate with a first DU via a source TRP serving a source cell. The at least one processor is further configured to, during or prior to execution of L1/L2-based inter-cell mobility for changing a serving cell of the UE from the source cell to a target cell provided by a target TRP, perform a multi-TRP operation between the source TRP and the target TRP. The L1/L2-based inter-cell mobility is intra-DU L1/L2-based inter-cell mobility within the first DU or inter-DU L1/L2-based inter-cell mobility from the first DU to a second DU.

A twelfth aspect is directed to a method performed by a UE. The method includes the steps of:

(a) communicating with a first DU via a source TRP serving a source cell; and
(b) during or prior to execution of L1/L2-based inter-cell mobility for changing a serving cell of the UE from the source cell to a target cell provided by a target TRP, performing a multi-TRP operation between the source TRP and the target TRP, wherein the L1/L2-based inter-cell mobility is intra-DU L1/L2-based inter-cell mobility within the first DU or inter-DU L1/L2-based inter-cell mobility from the first DU to a second DU.

A thirteenth aspect is directed to a second DU of a radio access network node. The second DU includes at least one memory and at least one processor coupled to the at least one memory. The at least one processor is configured to receive from a CU or a first DU of the radio access network node a first message related to preparation for L1/L2-based inter-cell mobility of a UE. The L1/L2-based inter-cell mobility is inter-DU L1/L2-based inter-cell mobility from a source cell associated with the first DU to a target cell associated with the second DU. The at least one processor is further configured to, in response to an access from the UE to the target cell, notify the CU or the first DU of a detection or completion of the L1/L2-based inter-cell mobility.

A fourteenth aspect is directed to a method performed by a second DU of a radio access network node. The method includes the steps of:

(a) receiving from a CU or a first DU of the radio access network node a first message related to preparation for L1/L2-based inter-cell mobility of a UE, wherein the L1/L2-based inter-cell mobility is inter-DU L1/L2-based inter-cell mobility from a source cell associated with the first DU to a target cell associated with the second DU; and
(b) in response to an access from the UE to the target cell, notifying the CU or the first DU of a detection or completion of the L1/L2-based inter-cell mobility.

A fifteenth aspect is directed to a UE. The UE includes at least one memory and at least one processor coupled to the at least one memory. The at least one processor is configured to provide an RRC layer and lower layers including a MAC layer and a PHY layer. The lower layers are configured to perform a random access procedure to a target cell for L1/L2-based inter-cell mobility, and to notify the RRC layer of completion of the L1/L2-based inter-cell mobility after completion of the random access procedure. The L1/L2-based inter-cell mobility is intra-DU L1/L2-based inter-cell mobility within a first DU or inter-DU L1/L2-based inter-cell mobility from the first DU to a second DU.

A sixteenth aspect is directed to a method performed by a UE. The method includes the steps of:

(a) providing an RRC layer and lower layers including a MAC layer and a PHY layer; and
(b) performing, by the lower layers, a random access procedure to a target cell for L1/L2-based inter-cell mobility and notifying, by the lower layers, the RRC layer of completion of the L1/L2-based inter-cell mobility after completion of the random access procedure, wherein the L1/L2-based inter-cell mobility is intra-DU L1/L2-based inter-cell mobility within a first DU or inter-DU L1/L2-based inter-cell mobility from the first DU to a second DU.

A seventeenth aspect is directed to a UE. The UE includes at least one memory and at least one processor coupled to the at least one memory. The at least one processor is configured to provide an RRC layer and lower layers including a MAC layer and a PHY layer. The lower layers are configured to perform a random access procedure to a target cell for L1/L2-based inter-cell mobility after notifying the RRC layer of execution of the L1/L2-based inter-cell mobility. The L1/L2-based inter-cell mobility is intra-DU L1/L2-based inter-cell mobility within a first DU or inter-DU L1/L2-based inter-cell mobility from the first DU to a second DU.

An eighteenth aspect is directed to a method performed by a UE. The method includes the steps of:

(a) providing an RRC layer and lower layers including a MAC layer and a PHY layer; and
(b) performing a random access procedure to a target cell for L1/L2-based inter-cell mobility after notifying the RRC layer of execution of the L1/L2-based inter-cell mobility, wherein the L1/L2-based inter-cell mobility is intra-DU L1/L2-based inter-cell mobility within a first DU or inter-DU L1/L2-based inter-cell mobility from the first DU to a second DU.

A nineteenth aspect is directed to a program. The program includes a set of instructions (software code) that, when read into a computer, causes the computer to perform the method according to the second, fourth, sixth, eighth, tenth, twelfth, fourteenth, sixteenth, or eighteenth aspect described above.

### Advantageous Effects of Invention

According to the aspects described above, it is possible to provide apparatuses, methods, and programs that contribute to solving at least one of a plurality of problems related to L1/L2-based inter-cell mobility, including the problems described above.

### BRIEF DESCRIPTION OF DRAWINGS

FIG. 1 shows an example configuration of a radio communication system according to an example embodiment;

FIG. 2 is a sequence diagram showing an example of signaling between a CU and a source DU according to an example embodiment;

FIG. 3 is a sequence diagram showing an example of signaling between a CU and a source DU according to an example embodiment;

FIG. 4 is a sequence diagram showing an example of signaling between a CU, a source DU, and a target DU according to an example embodiment;

FIG. 5 is a flowchart showing an example operation of a source DU according to an example embodiment;

FIG. 6 is a flowchart showing an example operation of a UE according to an example embodiment;

FIG. 7 is a sequence diagram showing an example of signaling between a CU, a source DU, and a UE according to an example embodiment;

FIG. 8 is a sequence diagram showing an example of signaling between a CU, a source DU, a target DU, and a UE according to an example embodiment;

FIG. 9 is a sequence diagram showing an example of signaling between a CU, a source DU, a target DU, and a UE according to an example embodiment;

FIG. 10 is a sequence diagram showing an example of signaling between a CU, a source DU, a target DU, and a UE according to an example embodiment;

FIG. 11 shows an example of layers that the UE has according to an example embodiment;

FIG. 12 is a flowchart showing an example operation of a UE according to an example embodiment;

FIG. 13 is a flowchart showing an example operation of a UE according to an example embodiment;

FIG. 14 is a flowchart showing an example operation of a UE according to an example embodiment;

FIG. 15 is a flowchart showing an example operation of a UE according to an example embodiment;

FIG. 16 is a sequence diagram showing an example of signaling between a CU, a source DU, a target DU, and a UE according to an example embodiment;

FIG. 17 is a sequence diagram showing an example of signaling between a CU, a source DU, and a target DU according to an example embodiment;

FIG. 18 is a sequence diagram showing an example of signaling between a CU, a source DU, and a target DU according to an example embodiment;

FIG. 19 is a block diagram showing an example configuration of a gNB-CU and a gNB-DU according to an example embodiment;

FIG. 20 is a block diagram showing an example configuration of a TRP according to an example embodiment; and

FIG. 21 is a block diagram showing an example configuration of a UE according to an example embodiment.

### EXAMPLE EMBODIMENT

Specific example embodiments will be described hereinafter in detail with reference to the drawings. Identical or corresponding elements are designated by the same symbols throughout the drawings, and duplicate explanations are omitted where necessary for the sake of clarity.

The multiple example embodiments described below may be implemented independently or in any suitable combination. These multiple example embodiments have novel features that differ from one another. Accordingly, these multiple example embodiments contribute to achieving different objectives or solving different problems and contribute to achieving different advantages.

The following example embodiments are described primarily with respect to the 3GPP Long Term Evolution (LTE) system and the 5th generation mobile communication system (5G system). However, these example embodiments can be applied to other radio communication systems that support technologies similar to 3GPP L1/L2-based inter-cell mobility. The term LTE as used herein includes improvements and enhancements to LTE and LTE-Advanced to enable interworking with 5G systems, unless otherwise specified.

As used in this specification, “if” can be interpreted to mean “when”, “at or around the time”, “after”, “upon”, “in response to determining”, “in accordance with a determination”, or “in response to detecting”, depending on the context. These expressions can be interpreted to mean the same thing, depending on the context.

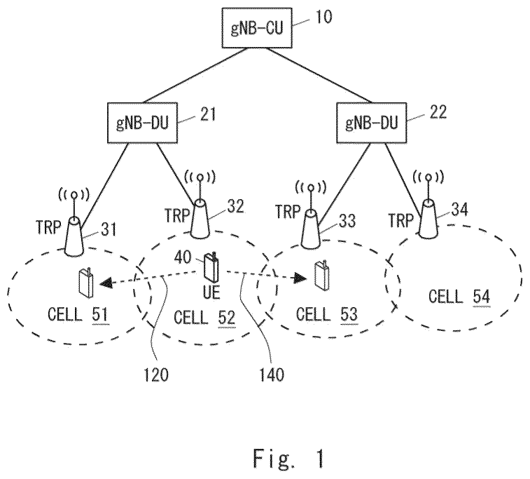

First, the configuration and operation of a plurality of network elements common to a plurality of example embodiments are described. FIG. 1 shows an example configuration of a radio communication system according to a plurality of example embodiments. In the example of FIG. 1, the radio communication system includes a gNB-CU 10, gNB-DUs 21 and 22, TRPs 31 to 34, and a UE 40. Each element (or network function) shown in FIG. 1 can be implemented, for example, as a network element on dedicated hardware, as a software instance running on dedicated hardware, or as a virtualized function instantiated on an application platform.

The gNB-CU 10, the gNB-DUs 21 and 22, and the TRPs 31 to 34 correspond to a single gNB. In other words, a single gNB includes the gNB-CU 10, the gNB-DUs 21 and 22, and the TRPs 31 to 34. A gNB is a Next Generation Radio Access Network (NG-RAN) node. A gNB may be referred to as a radio access network (RAN) node, base station, radio station, or access point. Each of the gNB-CU 10, the gNB-DUs 21 and 22, and the TRPs 31 to 34 may be referred to as a RAN node.

The gNB-CU 10 is a logical node that hosts the RRC, Service Data Adaptation Protocol (SDAP), and PDCP protocols of a gNB (or the RRC and PDCP protocols of a gNB). The gNB-CU 10 may contain a Control Plane (CP) unit (i.e., gNB-CU-CP) and one or more User Plane (UP) units (i.e., gNB-CU-UPs).

Each of the gNB-DUs 21 and 22 is a logical node that hosts the RLC and MAC layers of a gNB and part of the PHY layer of a gNB, i.e., the high PHY layer. The remaining PHY layer signaling, i.e., the low PHY layer, is located in the TRPs 31 to 34. In the example in FIG. 1, the gNB-DU 21 is connected to the TRPs 31 and 32, while the gNB-DU 22 is connected to the TRPs 33 and 34. The TRPs 31 to 34 provide different cells 51 and 54, respectively. In other words, the gNB-DU 21 provides a plurality of cells 51 and 52, and the TRPs 31 and 32 correspond to cells 51 and 52, respectively. Similarly, the gNB-DU 22 provides a plurality of cells 53 and 54, and the TRPs 33 and 34 correspond to cells 53 and 54, respectively.

Each of the TRPs 31 to 34 can communicate with the UE 40 using beams. The TRPs 31 to 34 may be referred to as Radio Units (RUs) or Remote Radio Heads (RRHs). Each of the TRPs 31 to 34 provides low PHY layer signal processing and analog Radio Frequency (RF) signal processing. Each TRP contains or is connected to one or more antenna arrays. Each TRP has a plurality of RF chains equal to or less than the total number of antenna elements in the one or more antenna arrays. Each TRP also includes a Digital Front End (DFE). The DFE provides low PHY layer signal processing and digital radio signal processing. The low PHY layer signal processing includes, for example, fast Fourier transform (FFT) and inverse FFT (IFFT). The low PHY layer signal processing may also include Cyclic Prefix (CP) addition and removal, and may include Physical RACH (PRACH) extraction or filtering. The digital radio signal processing may include, for example, digital pre-distortion (DPD), crest factor reduction (CFR), digital up conversion (DUC), digital down conversion (DDC), and transmit/receive baseband channel filter. The DFE may perform digital baseband precoding for beamforming. If a hybrid beamforming scheme is used, an analog beamformer circuit or analog precoder (e.g., phase shifter matrix) may be placed between the one or more antenna arrays and the multiple RF chains.

The interface between the gNB-CU 10 and each of the gNB-DUs 21 and 22 is an F1 interface. A direct interface, connection, or backhaul can be provided to connect the gNB-DU 21 and the gNB-DU 22. Similarly, a direct interface, connection, or backhaul can be provided to communicatively connect two TRPs serving neighbor cells, e.g., between the TRPs 31 and 32, between the TRPs 32 and 33, and between the TRPs 33 and 34.

The gNB-CU 10, gNB-DUs 21 and 22, TRPs 31 to 34 and UE 40 support beam management. Beam management is a set of L1/L2 procedures for obtaining and maintaining TRP(s) beams and UE beams that can be used for DL and UL transmission/reception. In addition, the gNB-CU 10, gNB-DUs 21 and 22, TRPs 31 to 34, and UE 40 support multi-TRP operation. Multi-TRP operation is one of the intra-cell and inter-cell beam management techniques. Multi-TRP operation includes 3GPP Release 16 or 17 multi-TRP operation. Specifically, the gNB-CU 10, gNB-DUs 21 and 22, TRPs 31 to 34, and UE 40 support multi-TRP PDSCH transmission. Multi-TRP PDSCH transmission involves non-coherent joint transmission (NCJT) of a Physical Downlink Shared Channel (PDSCH) from multiple TRPs to a single UE 40.

In NCJT, cooperating TRPs can transmit independent layers (or data streams) to the UE 40. In NCJT, each TRP transmits a different MIMO layer, so the requirements for synchronization and CSI accuracy are relatively low. Unlike other COMP technologies, NCJT requires little data exchange between TRPs. The NCJT operation handles each of the transmissions from the TRPs to the UE individually. That is, scheduling, rank and precoding matrix selection, and MCS selection can be done separately for each TRP.

As described above, there are two design approaches for multi-TRP PDSCH transmission, one is single PDCCH-based multi-TRP transmission and the other is multi-PDCCH-based multi-TRP transmission. In the case of single PDCCH-based multi-TRP transmission, a single DCI transmitted on a single PDCCH schedules a single multilayer PDSCH in which different PDSCH layers are transmitted from different transmission points. In contrast, in the case of multi-PDCCH-based multi-TRP transmission, PDCCHs from different TRPs schedule their respective PDSCHs. In other words, in multi-PDCCH-based multi-TRP transmission, there is a single PDSCH and associated transport block transmitted from each transmission point, and individual DCIs carried by individual PDCCHs schedule their respective PDSCHs.

Multi-TRP PDSCH transmission may be inter-cell multi-TRP PDSCH transmission. Inter-cell multi-TRP PDSCH transmission can be provided by TRPs (e.g., TRPs 31 and 32) and cells (e.g., cells 51 and 52) associated with a single gNB-DU (e.g., gNB-DU 21). In addition, inter-cell multi-TRP PDSCH transmission may be provided by TRPs (e.g., TRPs 32 and 33) and cells (e.g., cells 52 and 53) associated with different gNB-DUs 21 and 22. Inter-cell multi-TRP operation assumes multi-PDCCH based multi-TRP PDSCH transmission. The UE 40 can be configured with an SSB associated with a different PCI (i.e., an additional PCI) than the serving cell PCI. For example, the UE 40 can be configured with up to seven additional PCIs, only one of which may be activated in the case of inter-cell multi-TRP operation. An additional PCI can be associated with one or more TCI states. The gNB (e.g., gNB-DU21 or 22) can dynamically schedule a PDSCH from any TRP by dynamically indicating a TCI in a DCI.

The gNB-CU 10, gNB-DUs 21 and 22, TRPs 31 to 34, and UE 40 may support multi-TRP PDCCH repetition, multi-TRP PUSCH repetition, multi-TRP PUCCH repetition, or any combination thereof.

The gNB-CU 10, gNB-DUs 21 and 22, TRPs 31 to 34, and UE 40 support L1/L2-based inter-cell mobility of the UE 40. As described above, L1/L2-based inter-cell mobility can be considered as one of the network-controlled mobilities applicable to the UE 40 in RRC CONNECTED and involves a serving cell change for the UE 40. L1/L2-based inter-cell mobility may be a connection switching procedure by the L1 and L2 layers with a serving cell change. Alternatively, L1/L2-based inter-cell mobility may be a connection switching procedure by the L1 and L2 layers involving prompting the upper layer (i.e., the RRC layer) to perform a serving cell change. Alternatively, L1/L2-based inter-cell mobility may be a connection switching procedure that involves the L1 or L2 layer determining the execution of a serving cell change. Alternatively, L1/L2-based inter-cell mobility may be a connection switching procedure that involves the L1 or L2 layer triggering a serving cell change. Alternatively, L1/L2-based inter-cell mobility may be a serving cell change procedure in which a command indicating or triggering the execution of a serving cell change is transferred between the UE 40 and the gNB (e.g., gNB-DU 21 or 22) via L1 or L2 signaling without using L3 (RRC) signaling.

The decision to execute L1/L2-based inter-cell mobility can be made by the L1 or L2 (e.g., MAC layer) of any of the UE 40, source gNB-DU (e.g., gNB-DU 21), target gNB-DU (e.g., gNB-DU 22), or gNB-CU 10. For example, the L1 or L2 (e.g., MAC layer) of the UE 40 may determine the execution of L1/L2-based inter-cell mobility based on the results of L1 measurements of beams (e.g., SSBs or CSI-RSs) from multiple TRPs. For example, the results of L1 measurements can be SS Reference Signal Received Power (SS-RSRP), SS Reference Signal Received Quality (SS-RSRQ), SS Signal-to-Interference and Noise Ratio or Signal-to-Noise and Interference Ratio (SS-SINR), CSI-RSRP, CSI-RSRQ, CSI-SINR, or information about other L1 measurements. The L1 or L2 (e.g., MAC layer) of the source gNB-DU (e.g., gNB-DU 21) or target gNB-DU (e.g., gNB-DU 22) may determine the execution of L1/L2-based inter-cell mobility based on L1 measurements (e.g., SRS-RSRP) of beams (e.g., Sounding Reference Signal (SRS)) from the UE 40. Alternatively, the L1 or L2 of the source gNB-DU (e.g., gNB-DU 21) or target gNB-DU (e.g., gNB-DU 22) may receive a DL measurement report from the UE 40 via L1 or L2 signaling and determine the execution of L1/L2-based inter-cell mobility based on that DL measurement report. In the case where the decision to execute L1/L2-based inter-cell mobility is made by the gNB-CU 10, the receipt of a given L1 or L2-related information from the source or target gNB-DU may be used as a condition for determining the execution of the mobility. In other words, the gNB-CU 10 may decide to execute L1/L2-based inter-cell mobility in response to receiving a given L1 or L2-related information from the source or target gNB-DU.

Note that L1/L2-based inter-cell mobility does not completely preclude the use of L3 (RRC) signaling. For example, the UE 40 needs to be provided by the gNB (e.g., gNB-CU 10) with RRC configurations (e.g., serving cell configuration, cell group configuration) for a new serving cell (i.e., target cell). At least part of the RRC configurations of the new serving or target cell may be provided to the UE 40 via L3 (or RRC) signaling prior to the execution of L1/L2-based inter-cell mobility. In this case, the UE 40 may maintain the configurations of the current and new serving cells and switch between the two configurations in response to a decision or indication to perform L1/L2-based inter-cell mobility. Alternatively, at least part of the RRC configurations of the new serving or target cell may be provided to the UE 40 via L3 (or RRC) signaling after the execution of L1/L2-based inter-cell mobility.

L1/L2-based inter-cell mobility may be used for a PCell or SCG change for dual connectivity and a PSCell or SCG change for dual connectivity.

L1/L2-based inter-cell mobility may be referred to as L1/L2-based cell-level mobility, L1/L2-based handover, L1/L2-based PSCell change, or L1/L2-based Reconfiguration with sync. L1/L2-based inter-cell mobility may be referred to as L2-based inter-cell mobility, L2-based cell-level mobility, L2-based handover, L2-based PSCell change, or L2-based Reconfiguration with sync.

The mobility 120 shown in FIG. 1 is an intra-DU L1/L2-based inter-cell mobility. Specifically, the UE 40 moves from a beam in the cell 52 of the TRP 32 to a beam in the cell 51 of the TRP 31 associated with the same gNB-DU 21. In contrast, the mobility 140 shown in FIG. 1 is an inter-DU L1/L2-based inter-cell mobility. Specifically, the UE 40 moves from a beam in the cell 52 of the TRP 32 associated with the gNB-DU 21 to a beam in the cell 53 of the TRP 33 associated with the different gNB-DU 22.

Before and after L1/L2-based inter-cell mobility, the termination points of the radio bearers (e.g., Signaling Radio Bearers (SRBs), Data Radio Bearers (DRBs)) for the UE 40 are fixed and unchanged at the gNB-CU 10. One or more QoS flows belonging to the PDU Session of the UE 40 still pass through the same gNB-CU 10 (e.g., gNB-CU-UP) after L1/L2-based inter-cell mobility as before mobility. Accordingly, the radio bearer configuration at the UE 40 and the gNB (i.e., gNB-CU 10, or gNB-CU 10 and (target) gNB-DU 21 or 22) can be retained or maintained before and after L1/L2-based inter-cell mobility. Alternatively, the target gNB-DU (e.g., gNB-DU 22) or the gNB-CU 10 may transmit the radio bearer configuration for the target cell to the UE 40 via the source gNB-DU (e.g., gNB-DU 21) prior to performing L1/L2-based inter-cell mobility. If the UE 40 does not receive an explicit radio bearer configuration from the gNB (e.g., gNB-CU 10 or target gNB-DU) to be used after L1/L2-based inter-cell mobility, it may inherit the radio bearer configuration in the serving cell to the target cell. In other words, the UE 40 may continue to use the radio bearer configuration in the serving cell for the target cell.

From the UE perspective, the UE 40 may not need to know (i.e., may not be able to identify) whether L1/L2-based inter-cell mobility is performed within a DU or between DUs. Alternatively, the UE 40 may know (i.e., may be able to identify) whether L1/L2-based inter-cell mobility is performed within a DU or between DUs.

### First Example Embodiment

This example embodiment relates to preparation for L1/L2-based inter-cell mobility. An example configuration of a radio communication system in this example embodiment may be the same as the example configuration described with reference to FIG. 1.

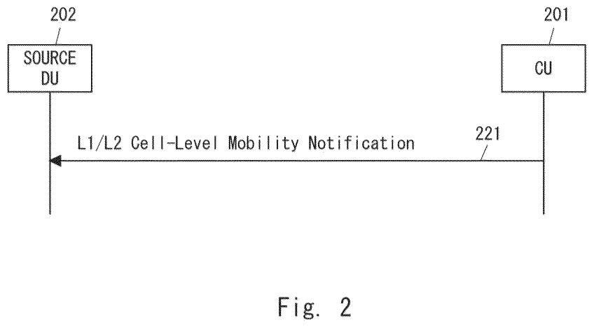

FIG. 2 shows an example of signaling regarding the preparation of L1/L2-based inter-cell mobility for a UE (e.g., UE 40). The L1/L2-based inter-cell mobility may be intra-DU L1/L2-based inter-cell mobility in the source gNB-DU 202. Alternatively, the L1/L2-based inter-cell mobility may be inter-DU L1/L2-based inter-cell mobility from the source gNB-DU 202 to another target gNB-DU. In step 221, the gNB-CU 201 sends to the source gNB-DU 202 a notification or message related to the L1/L2-based inter-cell mobility or its preparation.

The notification or message of step 221 may allow or request the source gNB-DU 202 to determine the execution of the L1/L2-based inter-cell mobility. The notification or message of step 221 may allow or request the source gNB-DU 202 to execute the L1/L2-based inter-cell mobility (e.g., to instruct the UE 40 to perform the L1/L2-based inter-cell mobility). In these cases, the source gNB-DU 202 may determine the execution of the L1/L2-based inter-cell mobility. This determination may be made by the L1 or L2 (e.g., MAC layer) of the source gNB-DU 202. Alternatively, the source gNB-DU 202 may perform the L1/L2 based inter-cell mobility. This execution can be performed by the L1 or L2 (e.g., MAC layer) of the source gNB-DU 202.

Further or alternatively, the notification or message of step 221 may allow or request the source gNB-DU 202 to provide the gNB-CU 201 with information necessary for the gNB-CU 201 to determine the execution of the L1/L2-based inter-cell mobility. In this case, the gNB-CU 201 may determine the execution of the L1/L2-based inter-cell mobility based on the information provided by the source gNB-DU 202. For example, the information necessary for the gNB-CU 201 to determine the execution of the L1/L2-based inter-cell mobility may be an L1 measurement result or L2 information based on an L1 measurement result. For example, the L2 information may indicate that a particular criterion for an L1 measurement or L1 measurement result has been met, or that the L2 has determined that L1/L2-based inter-cell mobility is required or recommended.

Further or alternatively, the notification or message of step 221 may include a configuration (e.g., serving cell configuration, cell group configuration) of one or more target cells. The configuration of one or more target cells can be generated by the gNB-CU 201 or the target gNB-DU, or both. The source gNB-DU 202 may transmit the configuration of one or more target cells to the UE. The configuration of one or more target cells may be included in an RRC message to be transmitted to the UE. In other words, the notification or message of step 221 may include an RRC message to be transmitted to the UE, and the RRC message may include a configuration of one or more target cells. The UE may retain the configuration of the current serving cell and the received configuration of one or more target cells (i.e., future serving cell candidates). Then, if the UE determines or is instructed to perform L1/L2-based inter-cell mobility to a target cell, the UE may switch the serving cell configuration from the current one to that of the determined target cell.

Additionally or alternatively, the notification or message of step 221 may include information indicating whether it is for intra-DU L1/L2-based inter-cell mobility or inter-DU L1/L2-based inter-cell mobility. This information may be flag information (e.g., 1-bit flag).

The notification or message of step 221 may be an F1 Application Protocol (F1AP) message (e.g., UE CONTEXT SETUP REQUEST message, UE CONTEXT MODIFICATION REQUEST message, or DL RRC MESSAGE TRANSFER message) sent from the gNB-CU 201 to the source gNB-DU 202. Alternatively, the notification or message of step 221 may be an information element included in an F1AP message sent from the gNB-CU 201 to the source gNB-DU 202. The notification or message of step 221 may be an inter-node RRC message carried by an F1AP message sent from the gNB-CU 201 to the source gNB-DU 202. This inter-node RRC message is an RRC message sent from the gNB-CU 201 to the source gNB-DU 202 via an F1AP interface. The inter-node RRC message may be included in a CU to DU RRC Information information element or a CU to DU RRC Container information element included in an F1AP message.

The operation shown in FIG. 2 allows the gNB-CU 201 to perform the preparation of intra-DU or inter-DU L1/L2-based inter-cell mobility with the source gNB-DU 202.

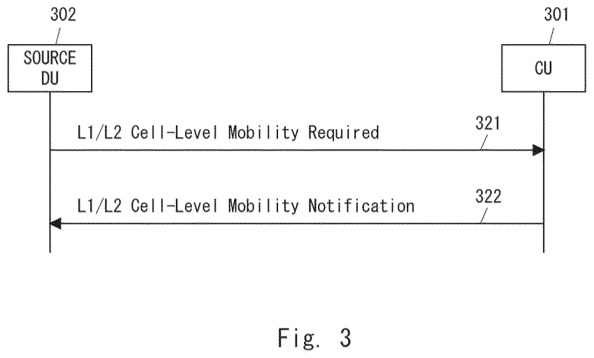

FIG. 3 shows another example of signalling related to the preparation of L1/L2-based inter-cell mobility for a UE (e.g., UE 40). The L1/L2-based inter-cell mobility may be intra-DU L1/L2-based inter-cell mobility in the source gNB-DU 302. Alternatively, the L1/L2-based inter-cell mobility may be inter-DU L1/L2-based inter-cell mobility from the source gNB-DU 302to another target gNB-DU. In step 321, the source gNB-DU 302 sends a request or message related to the L1/L2-based inter-cell mobility or its preparation to the gNB-CU 301. This may indicate to the gNB-CU 301 that the L1/L2-based inter-cell mobility is required. In step 322, the gNB-CU 301 sends a notification, response or message related to the L1/L2-based inter-cell mobility or its preparation to the source gNB-DU 302.

The request or message of step 321 may request the gNB-CU 301 to prepare the L1/L2-based inter-cell mobility. The gNB-CU 301 may determine whether the L1/L2-based inter-cell mobility is allowed or not and respond to the source gNB-DU 302 with a notification, response, or message in step 322. If the notification, response, or message in step 322 indicates permission, the source gNB-DU 302 may determine to perform the L1/L2-based inter-cell mobility. This determination may be made by the L1 or L2 (e.g., MAC layer) of the source gNB-DU 302. Alternatively, the notification, response, or message of step 322 may allow or request the source gNB-DU 302 to provide the gNB-CU 301 with information necessary for the gNB-CU 301 to determine the execution of the L1/L2-based inter-cell mobility. In this case, the gNB-CU 301 may determine the execution of the L1/L2-based inter-cell mobility based on the information provided by the source gNB-DU 302.

Further or alternatively, the request or message of step 321 may indicate one or more candidate target cells for the L1/L2-based inter-cell mobility. The gNB-CU 301 may include a configuration (e.g., serving cell configuration, cell group configuration) of the one or more candidate target cells in the notification, response, or message of step 322. The gNB-CU 301 may include a configuration of at least one target cell selected from the one or more candidate target cells in the notification, response, or message of step 322. The configuration of at least one (candidate) target cell may be generated by the gNB-CU 301 or the target gNB-DU, or both. The source gNB-DU 302 may transmit the configuration of one or more target cells to the UE. The configuration of one or more target cells may be included in an RRC message to be transmitted to the UE. In other words, the notification, response, or message of step 321 may include an RRC message to be transmitted to the UE, and the RRC message may include a configuration of one or more target cells. The UE may retain the configuration of the current serving cell and the received configuration of one or more target cells (i.e., future serving cell candidates). Then, if the UE determines or is instructed to perform L1/L2-based inter-cell mobility to a target cell, the UE may switch the serving cell configuration from the current one to that of the determined (or selected) target cell.

The request or message of step 321 may be an F1AP message (e.g., UE CONTEXT MODIFICATION REQUIRED message, or UL RRC MESSAGE TRANSFER message) sent from the source gNB-DU 302 to the gNB-CU 301. Alternatively, the request or message in step 321 may be an information element contained in an F1AP message sent from the source gNB-DU 302 to the gNB-CU 301. The request or message in step 321 may be an inter-node RRC message carried by an F1AP message sent from the source gNB-DU 302 to the gNB-CU 301. The inter-node RRC message may be included in a DU to CU RRC Information information element or a DU to CU RRC Container information element in an F1AP message.

The notification, response, or message of step 322 may be an F1AP message (e.g., UE CONTEXT SETUP REQUEST message, UE CONTEXT MODIFICATION REQUEST message, or DL RRC MESSAGE TRANSFER message) sent from the gNB-CU 301 to the source gNB-DU 302. Alternatively, the notification, response, or message of step 322 may be an information element included in an F1AP message sent from the gNB-CU 301 to the source gNB-DU 302. The notification, response, or message of step 322 may be an inter-node RRC message carried by an F1AP message sent from the gNB-CU 301 to the source gNB-DU 302. The inter-node RRC message may be included in a CU to DU RRC Information information element or a CU to DU RRC Container information element included in an F1AP message.

Additionally or alternatively, the notification, response, or message of step 322 may include information indicating whether it is for intra-DU L1/L2-based inter-cell mobility or inter-DU L1/L2-based inter-cell mobility. This information may explicitly indicate either intra-DU or inter-DU, or it may be flag information (e.g., a 1-bit flag indicating inter-DU mobility when flagged on).

The operation shown in FIG. 3 allows the gNB-CU 301 to perform the preparation of intra-DU or inter-DU L1/L2-based inter-cell mobility with the source gNB-DU 302.

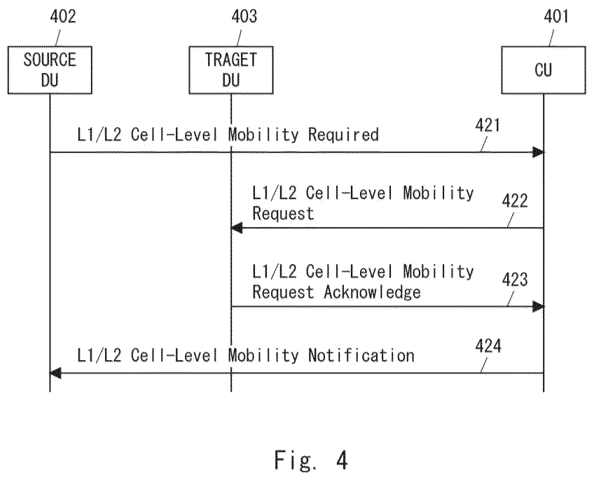

FIG. 4 shows yet another example of signaling related to the preparation of L1/L2-based inter-cell mobility for a UE (e.g., UE 40). This L1/L2-based inter-cell mobility is inter-DU L1/L2-based inter-cell mobility from the source gNB-DU 402 to the target gNB-DU 403.

In step 421, the source gNB-DU 402 sends a request or message related to the L1/L2-based inter-cell mobility or its preparation to the gNB-CU 401. The content of the request or message in step 421 may be similar to the content of the request or message in step 321 of FIG. 3, so that redundant explanation is omitted here.

In step 422, the gNB-CU 401 sends a request or message related to the L1/L2-based inter-cell mobility or its preparation to the target gNB-DU 403. In step 423, the target gNB-DU 403 sends a response or message related to the L1/L2-based inter-cell mobility or its preparation to the gNB-CU 401.

The request or message of step 422 may allow or request the target gNB-DU 403 to determine the execution of the L1/L2-based inter-cell mobility. The request or message of step 422 may allow or request the target gNB-DU 403 to execute the L1/L2-based inter-cell mobility (e.g., to instruct the UE 40 to perform the L1/L2-based inter-cell mobility). In these cases, the target gNB-DU 403 may determine the execution of the L1/L2-based inter-cell mobility. This determination may be made by the L1 or L2 (e.g., MAC layer) of the target gNB-DU 403. Alternatively, the target gNB-DU 403 may perform the L1/L2 based inter-cell mobility. This execution can be performed by the L1 or L2 (e.g., MAC layer) of the target gNB-DU 403.

Further or alternatively, the request or message of step 422 may allow or request the target gNB-CU 403 to provide the gNB-CU 401 with information necessary for the gNB-CU 401 to determine the execution of the L1/L2-based inter-cell mobility. In this case, the gNB-CU 401 may determine the execution of the L1/L2-based inter-cell mobility based on the information provided by the target gNB-DU 403.

Further or alternatively, the request or message of step 422 may request the target gNB-DU 403 to prepare the L1/L2-based inter-cell mobility. The request or message of step 422 may indicate one or more candidate target cells for the L1/L2-based inter-cell mobility. The target gNB-DU 403 may include a configuration (e.g., serving cell configuration, cell group configuration) of at least one target cell selected from the one or more target cells in the response or message of step 423.

In step 424, the gNB-CU 401 sends a notification, response, or message related to the L1/L2-based inter-cell mobility or its preparation to the source gNB-DU 402. A duplicate description is omitted here because the content of the notification, response, or message in step 424 may be similar to the content of the notification, response, or message in step 322 of FIG. 3.

The operation shown in FIG. 4 allows the gNB-CU 401 to perform the preparation of inter-DU L1/L2-based inter-cell mobility with the source gNB-DU 402 and the target gNB-DU 403.

The procedures for preparing L1/L2-based inter-cell mobility described with reference to FIG. 2 to FIG. 4 may be modified as follows. The gNB-CU may inform the gNB-DU not to initiate L1/L2-based inter-cell mobility if it decides to prepare for L3-based handover. This notification or message may include a Cause value or an indication indicating “L3 HO/Legacy HO In progress”. After receiving this notification or message, the gNB-DU may act to not initiate or refrain from preparing any L1/L2-based inter-cell mobility. For example, the gNB-DU may refrain from sending the message of step 321 in FIG. 3 or step 421 in FIG. 4.

After L1/L2-based inter-cell mobility has been prepared, the gNB-CU may decide to perform L3-based handover. In this case, the gNB-CU may inform the gNB-DU of the cancellation of the intra-DU L1/L2-based inter-cell mobility. Alternatively, the gNB-CU may inform the source gNB-DU or the target gNB-DU or both of the cancellation of the inter-DU L1/L2-based inter-cell mobility. In the example in FIG. 2, after step 221, the gNB-CU 201 may send a message to the gNB-DU 202 indicating the cancellation of the L1/L2-based inter-cell mobility. In the example in FIG. 3, after step 322, the gNB-CU 301 may send a message to the gNB-DU 302 indicating the cancellation of the L1/L2-based inter-cell mobility. In the example in FIG. 4, after step 424, the gNB-CU 401 may send a message to the source gNB-DU 402 or the target gNB-DU 403 or both indicating the cancellation of the L1/L2-based inter-cell mobility. These messages may include a Cause value or an indication indicating “L3 HO/Legacy HO In progress”. If the UE receives an L3-based handover instruction during the preparation (i.e., before the execution) of the L1/L2-based inter-cell mobility, it may abort the L1/L2-based inter-cell mobility and execute the L3-based handover. On the other hand, if the UE receives an L3-based handover instruction during the execution of the L1/L2-based inter-cell mobility, it may complete the L1/L2-based inter-cell mobility with priority.

While an L3-based inter-DU L3-based handover is being prepared at the target gNB-DU side, or after it has been prepared, the gNB-CU may receive a request or message (e.g., step 321 in FIG. 3, step 421 in FIG. 4) from the source gNB-DU regarding an L1/L2-based inter-cell mobility or its preparation. In this case, in an implementation, the gNB-CU may respond to the source gNB-DU with a message indicating that the L1/L2-based inter-cell mobility is not allowed or rejected. This response message may include a Cause value or an indication indicating “L3 HO/Legacy HO In progress”. In another implementation, the gNB-CU may abort the prepared L3-based handover. In this case, the gNB-CU may inform the target gNB-DU of the deletion of the UE context prepared for the L3-based handover using a UE Context Release procedure, and then request the target gNB-DU to prepare the L1/L2-based inter-cell mobility (e.g., step 422 in FIG. 4). Alternatively, the gNB-CU may request the target gNB-DU to use the UE context prepared for the L3-based handover for the L1/L2-based inter-cell mobility.

### Second Example Embodiment

This example embodiment relates to the use of multi-TRP operation in combination with L1/L2-based inter-cell mobility. An example configuration of a radio communication system in this example embodiment may be the same as the example configuration described with reference to FIG. 1.

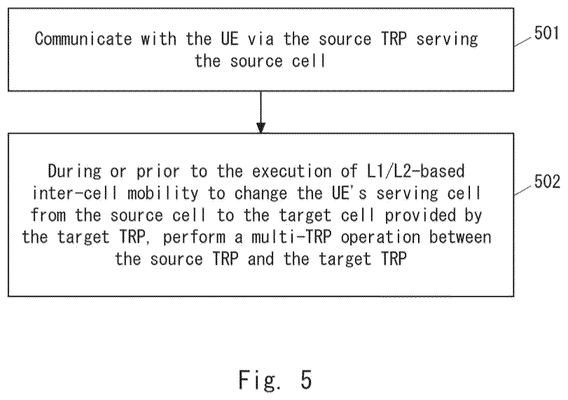

FIG. 5 shows an example of the operation of a source gNB-DU (e.g., gNB-DU 21) with respect to L1/L2-based inter-cell mobility. L1/L2-based inter-cell mobility may be intra-DU L1/L2-based inter-cell mobility within a source gNB-DU (e.g., gNB-DU 21). Alternatively, L1/L2-based inter-cell mobility may be inter-DU L1/L2-based inter-cell mobility from the source gNB-DU (e.g., gNB-DU 21) to the target gNB-DU (e.g., gNB-DU 22).

In step 501, the source gNB-DU (e.g., gNB-DU 21) communicates with the UE via the source TRP (e.g., TRP 32) serving the source cell. In other words, in step 501, the serving cell of the UE in RRC_CONNECTED is the source cell provided by the source TRP associated with the source gNB-DU.

In step 502, during or prior to the execution of L1/L2-based inter-cell mobility to change the UE's serving cell from the source cell to the target cell provided by the target TRP (e.g., TRP 31 or 33), the source gNB-DU performs a multi-TRP operation between the source TRP and the target TRP.

In or before step 502, the source gNB-DU may transmit, to the UE, information or RRC configuration (e.g., TCI-State configuration, additional PCI information, other beam management related information) required for the multi-TRP operation. The additional PCI information may be one or more additional PCIs. More specifically, the source gNB-DU may transmit the information or RRC configuration required for the multi-TRP operation to the UE during the preparation phase of L1/L2-based inter-cell mobility. The preparation phase of L1/L2-based inter-cell mobility may involve providing the UE with an RRC configuration (e.g., serving cell configuration, cell group configuration) related to the target cell.

The processing for the multi-TRP operation in step 502 may be provided by a combination of the source gNB-DU (e.g., gNB-DU 21) and the gNB-CU (e.g., gNB-CU 10). In other words, part of the processing for the multi-TRP operation in step 502 may be provided by the gNB-CU (e.g., gNB-CU 10). For example, the information or RRC configuration required for the multi-TRP operation may be provided by the gNB-CU to the UE in RRC signaling. More specifically, at least part of the information or RRC configuration required for the multi-TRP operation may be generated by the source gNB-DU and sent to the gNB-CU, and then the gNB-CU may transmit the information or RRC configuration required for the multi-TRP operation to the UE via the source gNB-DU. At this point, the gNB-CU may encrypt the information or RRC configuration required for the multi-TRP operation.

The information or RRC configuration required for the multi-TRP operation includes a TCI-State configuration and may include additional PCI information for inter-cell multi-TRP operation. The RRC configuration required for the multi-TRP operation may include other beam management related information. The TCI-State configuration specifies a plurality of TCI states. For example, each TCI state indicates a QCL relationship between an antenna port used for PDSCH transmission and an antenna port used for specific SSB or specific CSI-RS transmission. Additionally or alternatively, each TCI state indicates a QCL relationship between an antenna port used for PDCCH transmission and an antenna port used for specific SSB or specific CSI-RS transmission. In other words, each TCI state indicates a QCL relationship between a Demodulation Reference Signal (DMRS) port of the PDSCH or PDCCH and a specific downlink reference signal port.

In the case where an inter-DU multi-TRP operation is performed for inter-DU L1/L2-based inter-cell mobility, the source gNB-DU may share the configuration for the multi-TRP operation with the target gNB-DU. This may be done during or after L1/L2-based inter-cell mobility is prepared. For example, the target gNB-DU may send information about the target cell (e.g., SSB Measurement Timing Configuration (MTC), and TCI-related information) directly to the source gNB-DU or through the gNB-CU. The SSB-MTC information may be per-cell information shared in F1 setups, etc. The TCI-related information may be referred to as beam-related information. The TCI-related or beam-related information may include TCI state (or beam information). The TCI-related or beam-related information may include QCL-related information. The QCL-related information may specify the type of reference signal (e.g., SSB or CSI-RS) transmitted by the target TRP, the QCL relationship (or QCL type) between the source TRP and the target TRP, and so on. Part or all of the TCI-related or beam-related information may be provided to the source gNB-DU by a network operator, an Operation and Maintenance server, or another controller.

In or before step 502, the source gNB-DU may transmit a MAC CE to the UE to activate one or more of the plurality of TCI states configured by the RRC signaling. For example, the MAC CE may be used to activate up to 8 TCI states.

In the multi-TRP operation of step 502, the source gNB-DU may transmit a DCI indicating a PDSCH resource allocation to the UE from one of the two TRPs. The DCI indicates a TCI state. The UE decodes the PDSCH using the QCL information corresponding to the TCI state indicated in the DCI.

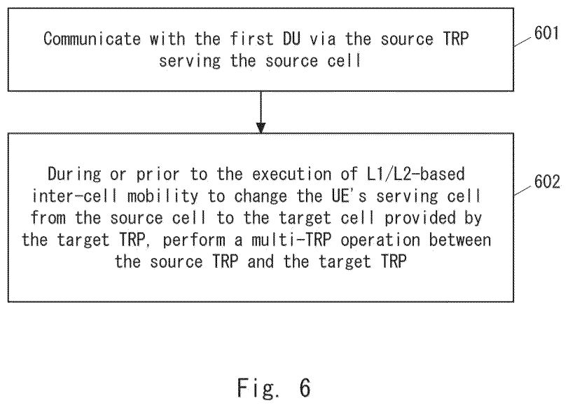

FIG. 6 shows an example of the operation of a UE (e.g., UE 40) with respect to L1/L2-based inter-cell mobility. The operation shown in FIG. 6 corresponds to or relates to the operation of the source gNB-DU (and gNB-CU) described with reference to FIG. 5.

In step 601, the UE communicates with the source gNB-DU (e.g., gNB-DU 21) via the source TRP (e.g., TRP 32) serving the source cell. In other words, in step 601, the serving cell of the UE in RRC_CONNECTED is the source cell provided by the source TRP associated with the source gNB-DU.

In step 602, during or prior to the execution of L1/L2-based inter-cell mobility to change the UE's serving cell from the source cell to the target cell provided by the target TRP (e.g., TRP 31 or 33), the UE performs a multi-TRP operation between the source TRP and the target TRP.

In or before step 602, the UE may receive information required for the multi-TRP operation (e.g., additional PCI information, TCI-State configuration, and other beam management related information) from the source gNB-DU. More specifically, the source gNB-DU may transmit the information required for the multi-TRP operation to the UE during the preparation phase of L1/L2-based inter-cell mobility. The preparation phase of L1/L2-based inter-cell mobility may involve providing the UE with an RRC configuration (e.g., serving cell configuration, cell group configuration) related to the target cell.

In or before step 602, the UE may receive a MAC CE from the source gNB-DU to activate one or more of the plurality of TCI states configured by the RRC signaling. For example, the MAC CE may be used to activate up to 8 TCI states.

In the multi-TRP operation of step 602, the UE may receive a DCI indicating a PDSCH resource allocation from the source gNB-DU via one of the two TRPs. The DCI indicates a TCI state. The UE decodes the PDSCH using the QCL information corresponding to the TCI state indicated in the DCI.

According to the operations described with reference to FIGS. 5 and 6, the source gNB-DU and the UE use multi-TRP operation during or before the L1/L2-based inter-cell mobility. This prepares the state where the L1 or L2 signaling transmitted between the source gNB-DU and the UE for the L1/L2-based inter-cell mobility is sent or received via the target TRP serving the target cell. This helps to improve the reachability of the L1 or L2 signaling for the L1/L2-based inter-cell mobility.

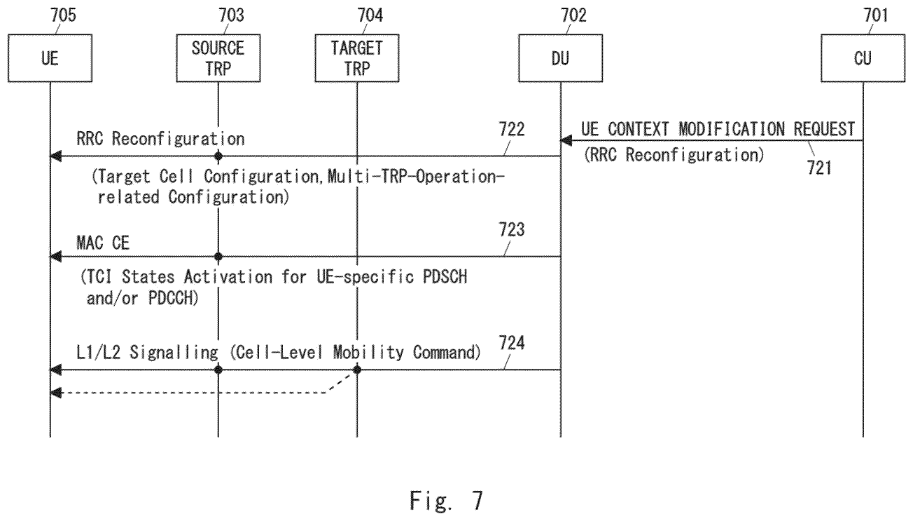

FIG. 7 shows an example of signaling related to intra-DU L1/L2-based inter-cell mobility. In step 721, a gNB-CU 701 sends an F1AP: UE CONTEXT MODIFICATION REQUEST message to a gNB-DU 702. The UE CONTEXT MODIFICATION REQUEST message contains an RRC Reconfiguration message to be sent to a UE 705. The RRC Reconfiguration message includes a configuration of the target cell for the intra-DU L1/L2-based inter-cell mobility, and also includes a configuration for multi-TRP operation. In step 722, the gNB-DU 702 sends the RRC Reconfiguration message to the UE 705 via a beam of the source cell provided by a source TRP 703.

The message in step 721 may be another message (e.g., another F1AP message) other than the F1AP: UE CONTEXT MODIFICATION REQUEST message. For example, in step 721, the gNB-CU 701 may send an F1AP: UE CONTEXT MODIFICATION CONFIRM message to the gNB-DU 702. This UE CONTEXT MODIFICATION CONFIRM message can be a response to an F1AP: UE CONTEXT MODIFICATION REQUIRED message (not shown) previously sent from the gNB-DU 702 to the gNB-CU 701. The UE CONTEXT MODIFICATION CONFIRM message may contain an RRC Reconfiguration message to be sent to the UE 705.

In step 723, the gNB-DU 702 transmits a MAC CE to the UE 705. To initiate the multi-TRP operation, the MAC CE indicates the activation of a TCI state(s) for one or both of a UE-specific PDSCH or PDCCH.

In step 724, the gNB-DU 702 sends L1 or L2 signaling to the UE 705 to instruct the UE 705 to perform the intra-DU L1/L2-based inter-cell mobility. A PDCCH or PDSCH containing this L1 or L2 signaling can be transmitted to the UE 705 via a beam of the target cell provided by a target TRP 704.

Alternatively, in step 724, the UE 705 may transmit, in the uplink to the gNB-DU 702, L1 or L2 signaling (e.g., an L1 or L2 measurement report or a mobility execution notification) regarding the intra-DU L1/L2-based inter-cell mobility. A PUCCH or PUSCH containing this L1 or L2 signaling can reach the gNB-DU 702 via a beam of the target cell provided by the target TRP 704. For example, the L1 measurement report may include the results of L1 measurements for an SSB or CSI-RS. The L2 measurement report may be L2 measurement information based on L1 measurement results. For example, the L2 measurement information may indicate that a particular criterion for an L1 measurement or L1 measurement result has been met, or that the L1/L2-based inter-cell mobility has been determined to be required or recommended.

After or in parallel with step 724, the UE 705 initiates an access (e.g., a random access procedure) to the target cell to change its serving cell to the target cell.

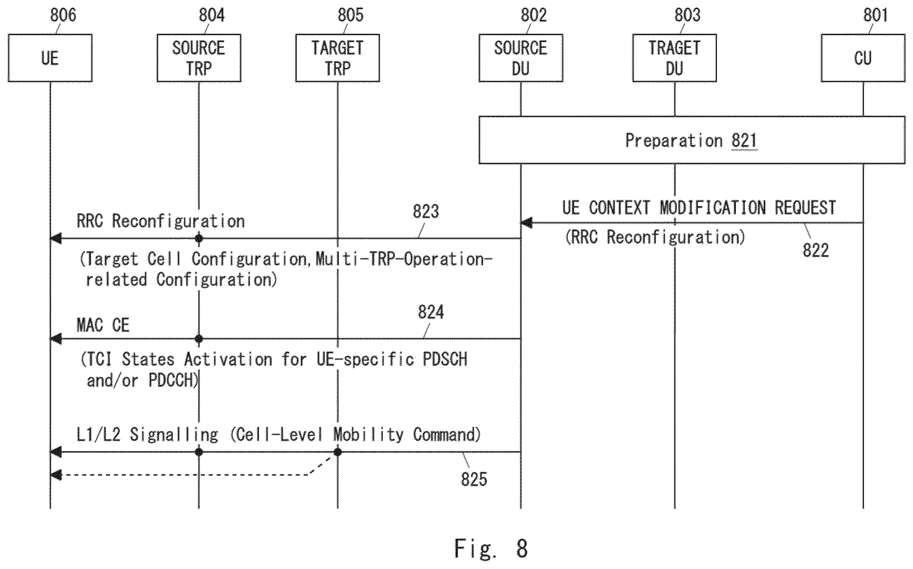

FIG. 8 shows an example of signaling related to inter-DU L1/L2-based inter-cell mobility. In step 821, a gNB-CU 801, a source gNB-DU 802, and a target gNB-DU 803 prepare for inter-DU L1/L2-based inter-cell mobility. This may be similar to any of the multiple examples described in the first example embodiment (e.g., FIG. 4).

In addition, in the preparation phase of step 821, the target gNB-DU 803 may control a target TRP 805 to perform a multi-TRP operation between a source TRP 804 belonging to the source gNB-DU 802 and the target TRP 805 belonging to the target gNB-DU 803. To achieve this, the source gNB-DU 802 may share a configuration related to the multi-TRP operation with the target gNB-DU 803. The target gNB-DU 803 may send information about the target cell (e.g., SSB-MTC and TCI-related information) directly to the source gNB-DU 802 or via the gNB-CU 801. The TCI-related information may be referred to as beam-related information. The TCI-related or beam-related information may include TCI state (or beam information). The TCI-related or beam-related information may include QCL-related information. The QCL-related information may specify the type of reference signal (e.g., SSB or CSI-RS) transmitted by the target TRP, the QCL relationship (or QCL type) between the source TRP and the target TRP, and so on. Part or all of the TCI-related or beam-related information may be provided to the source gNB-DU by a network operator, an Operation and Maintenance server, or another controller.

In step 822, a gNB-CU 801 sends an F1AP: UE CONTEXT MODIFICATION REQUEST message to the source gNB-DU 802. The UE CONTEXT MODIFICATION REQUEST message contains an RRC Reconfiguration message to be sent to a UE 806. The RRC Reconfiguration message includes a configuration of the target cell for the inter-DU L1/L2-based inter-cell mobility, and also includes a configuration for multi-TRP operation. In step 823, the source gNB-DU 802 sends the RRC Reconfiguration message to the UE 806 via a beam of the source cell provided by the source TRP 804.

The message in step 822 may be another message (e.g., another F1AP message) other than the F1AP: UE CONTEXT MODIFICATION REQUEST message. For example, in step 822, the gNB-CU 801 may send an F1AP: UE CONTEXT MODIFICATION CONFIRM message to the source gNB-DU 802. This UE CONTEXT MODIFICATION CONFIRM message can be a response to an F1AP: UE CONTEXT MODIFICATION REQUIRED message (not shown) previously sent from the source gNB-DU 802 to the gNB-CU 801. The UE CONTEXT MODIFICATION CONFIRM message may contain an RRC Reconfiguration message to be sent to the UE 806.

In step 824, the source gNB-DU 802 transmits a MAC CE to the UE 806. To initiate the multi-TRP operation, the MAC CE indicates the activation of a TCI state(s) for one or both of a UE-specific PDSCH or PDCCH.

In step 825, the source gNB-DU 802 sends L1 or L2 signaling to the UE 806 to instruct the UE 806 to perform the intra-DU L1/L2-based inter-cell mobility. A PDCCH or PDSCH containing this L1 or L2 signaling can be transmitted to the UE 705 via a beam of the target cell provided by the target TRP 805.

Alternatively, in step 825, the UE 806 may transmit, in the uplink to the source gNB-DU 802, L1 or L2 signaling (e.g., an L1 or L2 measurement report or a mobility execution notification) regarding the intra-DU L1/L2-based inter-cell mobility. A PUCCH or PUSCH containing this L1 or L2 signaling can reach the source gNB-DU 802 via a beam of the target cell provided by the target TRP 805.

Alternatively, in step 825, the target gNB-DU 803 may transmit L1 or L2 signaling to the UE 806 via a beam of the target cell provided by the target TRP 805. In other words, while performing the multi-TRP operation, the target gNB-DU 803 may instruct the UE 806 to change the serving cell from the source cell to the target cell with L1 or L2 signaling.

After or in parallel with step 825, the UE 806 initiates an access (e.g., a random access procedure) to the target cell to change its serving cell to the target cell. While performing the multi-TRP operation, the target gNB-DU 803 may detect the access of the UE 806 to change the serving cell of the UE 806 to the target cell.

### Third Example Embodiment

This example embodiment relates to inter-DU L1/L2-based inter-cell mobility. An example configuration of a radio communication system in this example embodiment may be the same as the example configuration described with reference to FIG. 1.

In inter-DU L1/L2-based inter-cell mobility (e.g., mobility 140 in FIG. 2), the target gNB-DU (e.g., gNB-DU 22) receives from the gNB-CU (e.g., gNB-CU 10) or the source gNB-DU (e.g., gNB-DU 21) a first message related to the preparation for the L1/L2-based inter-cell mobility. Then, in response to an access from the UE (e.g., UE 40) to the target cell (e.g., cell 53), the target gNB-DU (e.g., gNB-DU 22) notifies the gNB-CU (e.g., gNB-CU 10) or the source gNB-DU (e.g., gNB-DU 21) of the completion or detection of the L1/L 2-based inter-cell mobility. The target gNB-DU may detect the UE's access to the target cell based on the reception of a random access preamble, other L1 signalling, or other L2 signalling from the UE. This operation allows the gNB-CU or the source gNB-DU to know that the UE's access to the target cell for inter-DU L1/L2-based inter-cell mobility has been successfully completed.

The first message may indicate that the target gNB-DU is required or allowed to send an L1/L2-based inter-cell mobility instruction to the UE. In this case, the target gNB-DU may send an L1/L2-based inter-cell mobility instruction to the UE in response to receiving the first message. This indication may be L1 or L2 signaling.

The first message may allow or request the target gNB-DU to determine the execution of the L1/L2-based inter-cell mobility. The first message may allow or request the target gNB-DU to provide the gNB-CU with information necessary for the gNB-CU to determine the execution of the L1/L2-based inter-cell mobility.

In response to receiving the first message, the target gNB-DU may send a second message to the gNB-CU or the source gNB-DU indicating information about the target cell. For example, the first message may indicate one or more candidate target cells for the L1/L2-based inter-cell mobility. The target gNB-DU may include a configuration (e.g., serving cell configuration, cell group configuration) of at least one target cell selected from the one or more target cells in the second message.

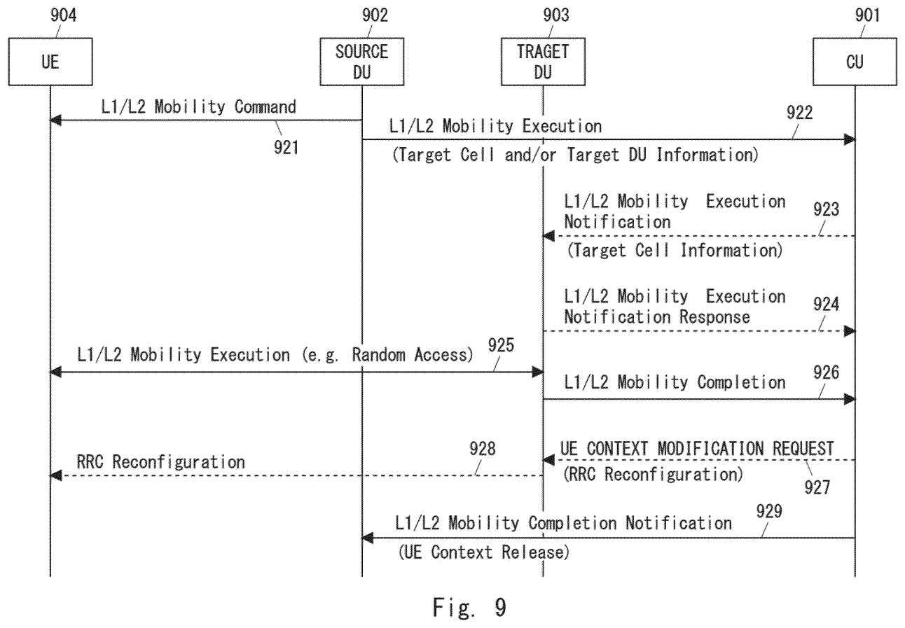

FIG. 9 shows an example of signaling for inter-DU L1/L2-based inter-cell mobility. The order of the steps described in FIG. 9 is not strict and can be modified as needed.

In step 921, a source gNB-DU 902 sends an L1/L2 mobility command to a UE 904. The L1/L2 mobility command instructs the UE 904 to perform inter-DU L1/L2-based inter-cell mobility. The L1/L2 mobility command may be an instruction to perform a multi-TRP operation. The L1/L2 mobility command may include an instruction to perform a multi-TRP operation. This is a multi TRP operation between a source TRP associated with the source gNB-DU 902 and a target TRP associated with a target gNB-DU 903. The L1/L2 mobility command may be L1 or L2 signaling. For example, the L1/L2 mobility command may be an indication of the start of the execution, information about the target cell (e.g., PCI), or a TCI state, or any combination thereof.

In step 922, the source gNB-DU 902 informs a gNB-CU 901 of the L1/L2 mobility execution. Step 922 may be performed prior to step 921. The notification of step 922 may indicate the target cell and may indicate the target gNB-DU 903. Alternatively, the notification of step 922 may include information about the target cell and may include information about the target gNB-DU 903.

In step 923, the gNB-CU 901 sends an L1/L2 mobility execution notification to the target gNB-DU 903. The notification of step 923 may indicate the target cell. Alternatively, the notification of step 923 may include information about the target cell. In step 924, the target gNB-DU 903 sends a response to the gNB-CU 901. The response may include a configuration of the target cell (e.g., serving cell configuration, cell group configuration). Prior to steps 921 and 922, the preparation phase described in the first example embodiment (e.g., FIG. 4) may be performed. In this case, step 924 or steps 923 and 924 may be omitted.

In step 925, the UE 904 performs the inter-DU L1/L2-based inter-cell mobility. Specifically, the UE 904 accesses a cell of a target TRP associated with the target gNB-DU 903. In this case, the UE 904 may perform a random access procedure in the target cell.

In step 926, the target gNB-DU 903 notifies the gNB-CU 901 of the completion of the L1/L2-based inter-cell mobility.

In steps 927 and 928, the gNB-CU 901 sends an RRC Reconfiguration message containing a target cell configuration to the UE 904 via the target gNB-DU 903. Specifically, in step 927, the gNB-CU 901 sends an F1AP: UE CONTEXT MODIFICATION REQUEST message to the target gNB-DU 903. The UE CONTEXT MODIFICATION REQUEST message contains an RRC Container information element that contains an RRC Reconfiguration message to be sent to the UE 904. In step 928, the target gNB-DU 903 transmits the RRC Reconfiguration message via the target TRP and the target cell to the UE 904.

Steps 927 and 928 may be omitted. For example, as described above, the RRC configuration (or RRC Reconfiguration message) including the target cell configuration may be sent from the gNB-CU 901 to the UE 904 via the source gNB-DU 902 during the preparation phase of L1/L2-based inter-cell mobility. In this case, the UE 904 may maintain the current serving cell configuration and the received target cell (i.e., future serving cell candidate) configuration and switch the serving cell configuration from the current one to that of the target cell in response to the execution of the L1/L2-based inter-cell mobility.

In step 929, the gNB-CU 901 notifies the source gNB-DU 902 of the completion of the L1/L2 mobility. Step 929 may be performed before step 927. The notification of step 929 may instruct the source gNB-DU 902 to release the UE context held by the source gNB-DU 902. The notification of step 929 may be an F1AP UE CONTEXT RELEASE COMMAND message or an information element contained in this message.

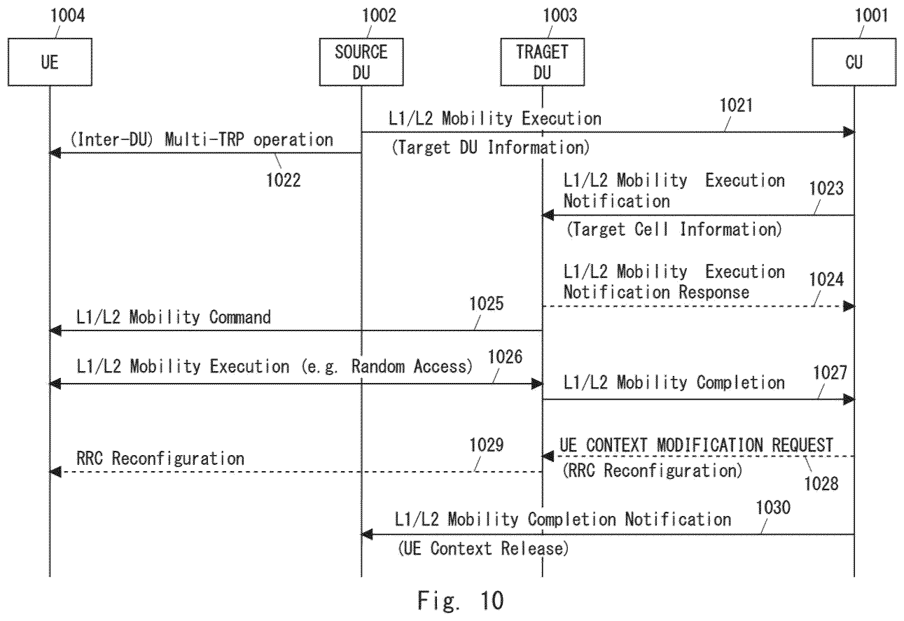

FIG. 10 shows another example of signaling for inter-DU L1/L2-based inter-cell mobility. The order of the steps described in FIG. 10 is not strict and can be modified as needed.

In step 1021, a source gNB-DU 1002 informs a gNB-CU 1001 of the execution of L1/L2 mobility. The notification of step 1021 may indicate a target cell and may indicate a target gNB-DU 1003. Alternatively, the notification of step 1021 may include information about the target cell and may include information about the target gNB-DU 1003.

In step 1022, the source gNB-DU 1002 sends an instruction for a multi-TRP operation to the UE 1004. This is a multi-TRP operation between a source TRP associated with the source gNB-DU 1002 and a target TRP associated with the target gNB-DU 1003. Step 1022 may be performed before step 1021.

The instruction in step 1022 is L3 signaling (e.g., RRC messages), L2 signaling (e.g., MAC CE), or L1 signaling (e.g., DCI). More specifically, the instruction in step 1022 may be an RRC Reconfiguration message containing an RRC configuration (e.g., TCI-State configuration, additional PCI information, or other beam management-related information) required for the multi-TRP operation. In this case, the source gNB-DU 1002 may request the CU 1001 to modify the established UE context via an F1AP message (e.g., UE CONTEXT MODIFICATION REQUIRED message). The source gNB-DU 1002 then receives an F1AP message (e.g., UE CONTEXT MODIFICATION CONFIRM message) from the CU 1001 carrying an RRC Reconfiguration message containing the RRC configuration required for the multi-TRP operation, and may transmit this RRC Reconfiguration message to the UE 1004 in step 1022. Alternatively, the instruction of step 1022 may be a MAC CE to activate one or more of a plurality of TCI states configured by RRC signaling. Alternatively, the instruction of step 1022 may be a DCI indicating a PDSCH resource allocation for the multi-TRP operation. The DCI indicates a TCI state. The UE 1004 decodes the PDSCH using the QCL information corresponding to the TCI state indicated in the DCI.

In step 1023, the gNB-CU 1001 sends a L1/L2 mobility execution notification to the target gNB-DU 1003. The notification of step 1023 may be an information element contained in an F1AP message sent from the gNB-CU 1001 to the target gNB-DU 1003. The notification of step 1023 may be an inter-node RRC message carried in an F1AP message sent from the gNB-CU 1001 to the target gNB-DU 1003. The inter-node RRC message may be contained in a CU to DU RRC Information information element included in the F1AP message.

In step 1024, the target gNB-DU 1003 sends a response to the gNB-CU 1001. The response may include a target cell configuration (e.g., serving cell configuration, cell group configuration). The target cell configuration may be included in an inter-node RRC message carried in an F1AP message sent from the target gNB-DU 1003 to the gNB-CU 1001. The inter-node RRC message may be contained in a DU to CU RRC Information information element included in the F1AP message. The preparation phase described in the first example embodiment (e.g., FIG. 4) may be performed before steps 1021 and 1022. In this case, step 1024 may be omitted.

In step 1025, the target gNB-DU 1003 sends an L1/L2 mobility command to the UE 1004 via the target cell.

In step 1026, the UE 1004 performs the inter-DU L1/L2-based inter-cell mobility. Steps 1026-1030 are similar to steps 925-929 in FIG. 9, so duplicate explanations are omitted here.

### Fourth Example Embodiment

This example embodiment relates to an internal operation of a UE in L1/L2-based inter-cell mobility. An example configuration of a radio communication system in this example embodiment may be the same as the example configuration described with reference to FIG. 1. The L1/L2-based inter-cell mobility may be intra-DU L1/L2-based inter-cell mobility or inter-DU L1/L2-based inter-cell mobility. From the UE perspective, the UE may not need to know (i.e., may not be able to identify) whether L1/L2-based inter-cell mobility is performed within a DU or between DUs. Alternatively, the UE may know (i.e., may be able to identify) whether L1/L2-based inter-cell mobility is performed within a DU or between DUs.

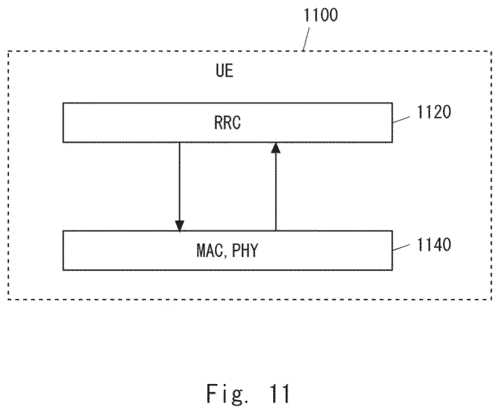

As shown in FIG. 11, a UE 1100 includes an RRC layer 1120 and includes lower layers 1140, including a MAC layer and a PHY layer. The lower layers 1140 may further include SDAP, PDCP, and RLC layers.

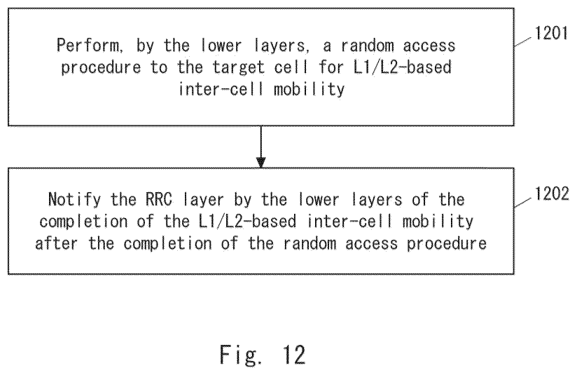

FIG. 12 shows a first example of the operation of the UE 1100. In step 1201, the lower layers 1140 perform a random access procedure to a target cell for L1/L2-based inter-cell mobility. The lower layers 1140 may perform the process of step 1201 in response to receiving an L1 or L2 signaling from a source gNB-DU or a target gNB-DU for instructing the execution of the L1/L2-based inter-cell mobility. Alternatively, the lower layers 1140 may perform the process of step 1201 in response to an execution condition for the L1/L2-based inter-cell mobility being satisfied. In other words, the lower layers 1140 may perform the process of step 1201 if the lower layers 1140 have determined that an execution condition for the L1/L2-based inter-cell mobility is satisfied.

In step 1202, after completion of the random access procedure, the lower layers 1140 (e.g., MAC layer) notify the RRC layer 1120 of the completion of the L1/L2-based inter-cell mobility. In response to this notification, the RRC layer 1120 may generate an RRC Reconfiguration Complete message and request the lower layers 1140 to send the RRC Reconfiguration Complete message. The lower layers 1140 may send the RRC Reconfiguration Complete message in the target cell and notify the RRC layer 1120 of the completion of the transmission. In the case of a Contention-Based Random Access (CBRA) of the 4-step random access type, the completion of the random access procedure may mean receiving a fourth message (MSG4, Contention Resolution). In the case of a Contention-Free Random Access (CFRA) of the 4-step random access type, the completion of the random access procedure may mean the receiving of a second message (MSG2, Random Access Response). In the case of a CBRA of the two-step random access type, the completion of the random access procedure may mean receiving a second message (MSGB, Contention Resolution). In the case of a CFRA of the two-step random access type, the completion of the random access procedure may mean receiving a second message (MSGB, Random Access Response).

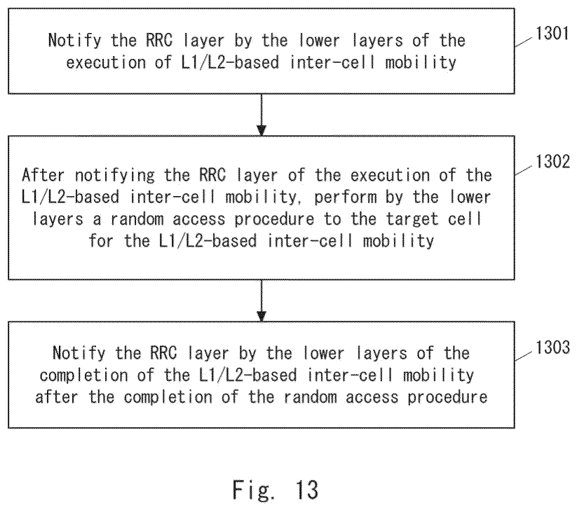

FIG. 13 shows a second example of the operation of the UE 1100. In step 1301, the lower layers 1140 notify the RRC layer 1120 of the execution of L1/L2-based inter-cell mobility. In other words, the lower layers 1140 notify the RRC layer 1120 of the execution of L1/L2-based inter-cell mobility prior to performing a random access procedure to the target cell. The lower layers 1140 may perform the process of step 1301 in response to receiving an L1 or L2 signaling from the source gNB-DU or the target gNB-DU for instructing the execution of the L1/L2-based inter-cell mobility. Alternatively, the lower layer 1140 may perform the process of step 1301 in response to an execution condition for the L1/L2-based inter-cell mobility being satisfied. In other words, the lower layer 1140 may perform the process of step 1301 if the lower layers 1140 have determined that an execution condition for the L1/L2-based inter-cell mobility is satisfied.

In step 1302, after notifying the RRC layer of the execution of the L1/L2-based inter-cell mobility, the lower layers 1140 perform a random access procedure to the target cell for the L1/L2-based inter-cell mobility. In step 1303, after completing the random access procedure, the lower layers 1140 notify the RRC layer 1120 of the completion of the L1/L2-based inter-cell mobility. In response to the notification of step 1301, the RRC layer 1120 may generate an RRC Reconfiguration Complete message and request the lower layers 1140 to transmit the RRC Reconfiguration Complete message. The lower layers 1140 may transmit the RRC Reconfiguration Complete message in the target cell. In this case, the lower layers 1140 may notify the RRC layer 1120 of the completion of the L1/L2-based inter-cell mobility in response to the completion of the random access procedure and the completion of the transmission of the RRC Reconfiguration Complete message.

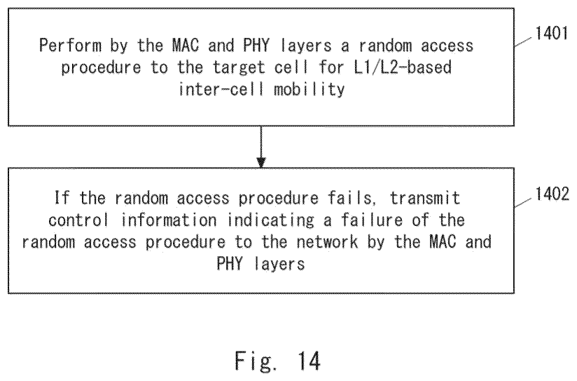

FIG. 14 shows a third example of the operation of the UE 1100. Step 1401 is the same as step 1201 in FIG. 12. In step 1402, the random access procedure performed in the target cell for L1/L2-based inter-cell mobility fails. In response, the lower layers 1140 transmit control information to the network indicating a failure of the random access procedure. The control information may be Layer 1 or Layer 2 signaling, or it may be a MAC CE. The control information may indicate a failure of the L1/L2-based inter-cell mobility (e.g., L1/L2 mobility failure). The control information may indicate a beam failure. The control information may be transmitted to the source gNB-DU via the source cell or to a gNB-DU via a cell other than the source cell and the target cells.

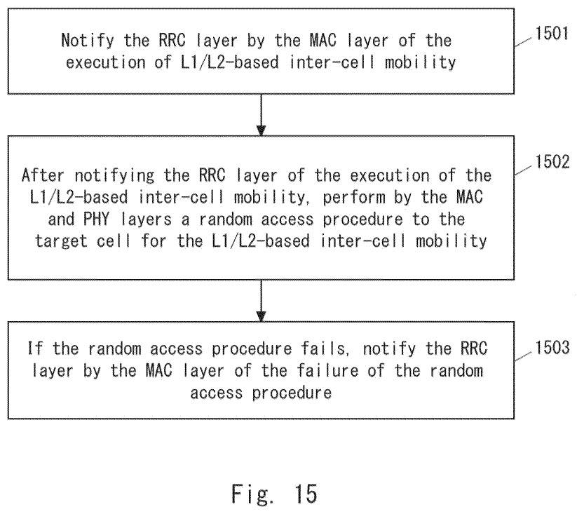

FIG. 15 shows a fourth example of the operation of the UE 1100. Steps 1501 and 1502 are the same as steps 1301 and 1302 in FIG. 13. In step 1503, the random access procedure performed in the target cell for L1/L2-based inter-cell mobility fails. In response, the lower layers 1140 notify the RRC layer 1120 of the failure of the random access procedure. The lower layer 1140 may explicitly notify the RRC layer 1120 of the failure of the L1/L2-based inter-cell mobility. The RRC layer 1120 may discard a generated RRC Reconfiguration Complete message. Similar to step 1402 of FIG. 14, the lower layer 1140 may transmit control information to the network indicating a failure of the random access procedure.

In this example embodiment, the UE 1100 may transmit and receive L1 or L2 signaling in the target cell to complete the L1/L2-based inter-cell mobility instead of the random access procedure. For example, the lower layers 1140 of the UE 1100 transmit a PUCCH or PUSCH containing L1 or L2 signaling (e.g., a MAC CE). In addition, the lower layers 1140 of the UE 1100 receive a PDCCH or PDSCH containing L1 or L2 signaling (e.g., a MAC CE). With these steps, the UE 1100 may determine that the L1/L2-based inter-cell mobility is complete.

The operation of the UE described in this example embodiment can provide interactions between the RRC layer and the lower layers (e.g., MAC and PHY layers) with respect to L1/L2-based inter-cell mobility.

### Fifth Example Embodiment

This example embodiment relates to the operation in the case where a failure of inter-DU L1/L2-based inter-cell mobility occurs (e.g., when a radio link failure occurs) or where inter-DU L1/L2-based inter-cell mobility is aborted. An example configuration of a radio communication system in this example embodiment may be the same as the example configuration described with reference to FIG. 1.

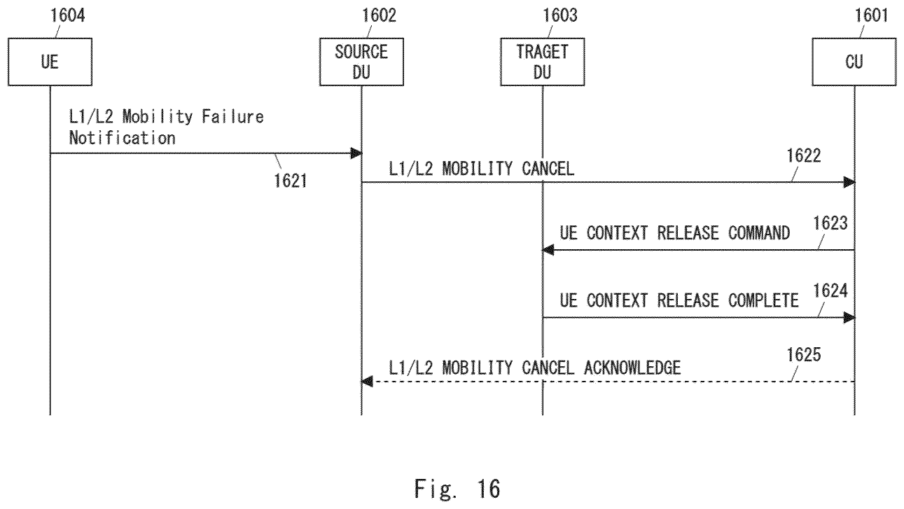

FIG. 16 shows an example of signaling for inter-DU L1/L2-based inter-cell mobility. The order of the steps described in FIG. 16 is not strict and can be modified as needed. The procedure of FIG. 16 is initiated by a UE 1604. Specifically, in step 1621, if the UE 1604 has failed in a random access to a target TRP, it notifies a source gNB-DU 1602. The notification may be transmitted, for example, by L2 signaling (e.g., a MAC CE). The notification may indicate an L1/L2 Mobility Failure. In step 1622, the source gNB-DU 1602 sends an L1/L2 MOBILITY CANCEL message to a gNB-CU 1601. The L1/L2 MOBILITY CANCEL message may contain a Cause information element indicating “L1/L2 Mobility Failure”.

In step 1623, the gNB-CU 1601 sends a UE CONTEXT RELEASE COMMAND message to a target gNB-DU 1603. The UE CONTEXT RELEASE COMMAND message may contain a Cause information element indicating “L1/L2 Mobility Failure”. The target gNB-DU 1603 may release the UE context and release the prepared resources of the target cell. In step 1624, the target gNB-DU 1603 responds to the gNB-CU 1601 with a UE CONTEXT RELEASE COMPLETE message. In step 1625, the gNB-CU 1601 responds to the source gNB-DU 1602 with an L1/L2 MOBILITY CANCEL ACKNOWLEDGE message. Step 1625 can be omitted.

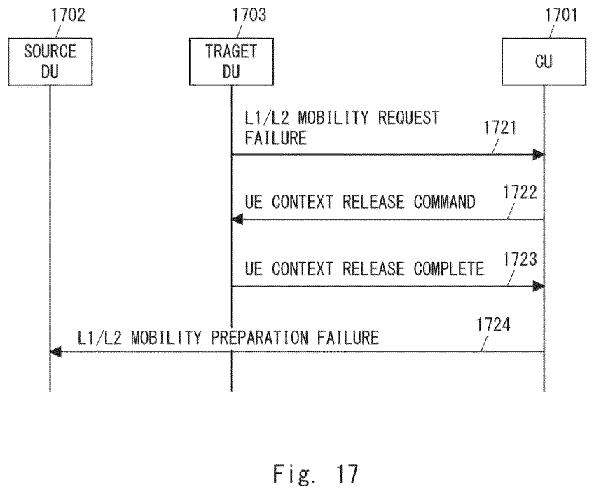

FIG. 17 shows another example of signaling for inter-DU L1/L2-based inter-cell mobility. The order of the steps described in FIG. 17 is not strict and can be modified as needed. The procedure of FIG. 17 is initiated by a target gNB-DU 1703. Specifically, in step 1721, the target gNB-DU 1703 detects a timeout before a successful random access from a UE to a target cell. In response, the target gNB-DU 1703 sends an L1/L2 MOBILITY REQUEST FAILURE message, or UE CONTEXT RELEASE REQUEST message, to a gNB-CU 1701. This message may contain a Cause information element indicating “L1/L2 Mobility Failure”.

In step 1722, the gNB-CU 1701 sends a UE CONTEXT RELEASE COMMAND message to the target gNB-DU 1703. The UE CONTEXT RELEASE COMMAND message may contain a Cause information element indicating “L1/L2 Mobility Failure”. The target gNB-DU 1703 may release the UE context and release the prepared resources of the target cell. In step 1723, the target gNB-DU 1703 responds to the gNB-CU 1701 with a UE CONTEXT RELEASE COMPLETE message.

In step 1724, the gNB-CU 1701 sends an L1/L2 MOBILITY PREPARATION FAILURE message to a source gNB-DU 1702. This message may contain a Cause information element indicating “L1/L2 Mobility Failure”. Sending of the message in step 1724 may occur before step 1722 or before step 1723.

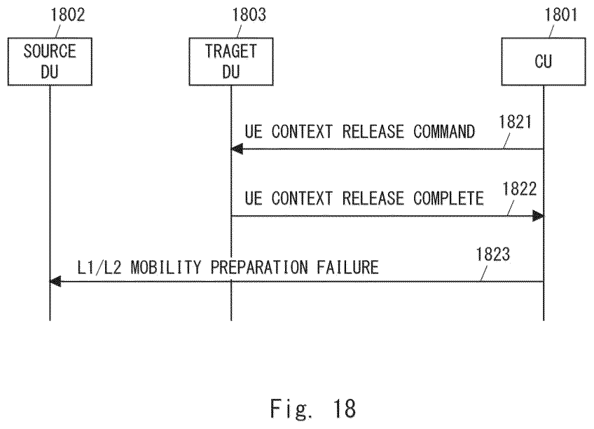

FIG. 18 shows yet another example of signaling for inter-DU L1/L2-based inter-cell mobility. The order of the steps described in FIG. 18 is not strict and can be modified as needed. The procedure of FIG. 18 is initiated by a gNB-CU 1801. Specifically, in step 1821, the gNB-CU 1801 determines to abort the L1/L2-based inter-cell mobility of the UE for some reason. For example, after the L1/L2-based inter-cell mobility for the UE has been prepared, the gNB-CU 1801 may decide to abort the L1/L2-based inter-cell mobility in response to a decision to perform an L3-based handover of the UE. Further or alternatively, the gNB-CU 1801 may determine to abort the L1/L2-based inter-cell mobility of the UE in response to receiving from the core network a request for some change regarding the UE. In response, the gNB-CU 1801 sends a UE CONTEXT RELEASE COMMAND message to a target gNB-DU 1803. The UE CONTEXT RELEASE COMMAND message may contain a Cause information element indicating “L1/L2 Mobility Cancel”. Additionally or alternatively, the UE CONTEXT RELEASE COMMAND message may contain a Cause value or indication indicating “L3 HO/Legacy HO In progress”. The target gNB-DU 1803 may release the UE context and release the prepared resources of the target cell. In step 1822, the target gNB-DU 1803 responds to the gNB-CU 1801 with a UE CONTEXT RELEASE COMPLETE message.

In step 1823, the gNB-CU 1801 sends an L1/L2 MOBILITY PREPARATION FAILURE message to a source gNB-DU 1802. This message may contain a Cause information element indicating “L1/L2 Mobility Cancel”. Sending of the message in step 1824 may occur before step 1821 or before step 1822.

The procedures described in this example embodiment can be used to address a failure of inter-DU L1/L2-based inter-cell mobility or the case where inter-DU L1/L2-based inter-cell mobility is aborted.

### Another Example Embodiment 1

The UE (e.g., UE 40) may perform the following actions during or after the execution of L1/L2-based inter-cell mobility. For example, the UE switches configuration information (e.g., RRC layer parameters) for the PHY layer from that used in the serving cell to that associated with the target cell. Additionally or alternatively, the UE releases the radio resources allocated in the serving cell. For example, the UE resets the MAC layer or entity and switches configuration information (e.g., RRC parameters) for the MAC layer or entity from that used in the serving cell to that associated with the target cell. For example, the UE releases, reconfigures, or re-establishes the RLC layer or entity. On the other hand, the UE may not reconfigure or re-establish the PDCP layer or entity, and may continue the process of the PDCP layer or entity that was configured or established prior to the L1/L2-based inter-cell mobility after the L1/L2-based inter-cell mobility is completed. At this point, the UE may retain state variables (e.g., State variable(s)) of the PDCP layer or entity.

### Another Example Embodiment 2

The UE (e.g., UE 40) may detect degradation of the radio link quality (e.g., Radio Link Failure (RLF)) during or before the execution of L1/L2-based inter-cell mobility or after its completion (e.g., immediately after its completion). For example, the UE stores information about the RLF and later reports information about that RLF to a RAN node (e.g., gNB, gNB-CU 10). In this case, the UE may include information about L1/L2-based inter-cell mobility in the information about the RLF. For example, the information about L1/L2-based inter-cell mobility may indicate that the RLF was detected during the execution of L1/L2-based inter-cell mobility. Alternatively, the information about L1/L2-based inter-cell mobility may include information indicating when the RLF was detected: during the execution of L1/L2-based inter-cell mobility, after configuration and before the start of L1/L2-based inter-cell mobility, or after the completion of L1/L2-based inter-cell mobility (e.g., immediately after the completion). Additionally or alternatively, if L1/L2-based inter-cell mobility fails, the UE may store information indicating this (e.g., L1/L2 mobility failure information) and later report it to a RAN node, for example, by a procedure similar to RLF reporting. A failure of L1/L2-based inter-cell mobility may include an RLF during or before the execution of L1/L2-based inter-cell mobility or after its completion. Additionally or alternatively, a failure of L1/L2-based inter-cell mobility may be determined by the expiration of a timer associated with the L1/L2-based inter-cell mobility (e.g., a timer in the MAC layer), or by the failure to complete the mobility by the expiration.

### Another Example Embodiment 3

If L1/L2-based inter-cell mobility fails, the UE (e.g., UE 40) may return to the source cell. For example, the UE may resume or continue transmitting or receiving signals in the source cell with the same configuration as before the start of the L1/L2-based inter-cell mobility. Alternatively, the UE may switch to the configuration before the start of the L1/L2-based inter-cell mobility and start transmitting or receiving signals in the source cell. Additionally or alternatively, the UE may attempt to perform L1/L2-based inter-cell mobility to another candidate target cell of the L1/L2-based inter-cell mobility. The RAN node (e.g., gNB, gNB-CU 10) may specify in advance to the UE which of the multiple actions described above should be performed in the event of an L1/L2-based inter-cell mobility failure. Alternatively, the UE may select one or more of these multiple actions. The UE may decide which action to take based on configuration information for the L1/L2-based inter-cell mobility received from the RAN node 2.

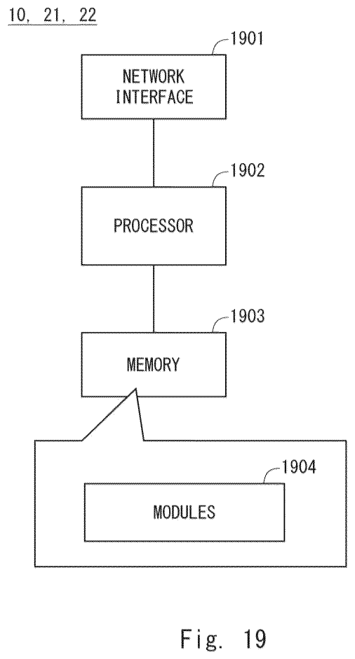

The following describes example configurations of the gNB-CU 10, the gNB-DUs 21 and 22, the TRPs 31 to 34, and the UE 40 shown in FIG. 1. FIG. 19 shows a block diagram of an example configuration of the gNB-CU 10. The configuration of the gNB-DUs 21 and 22 may be similar to that shown in FIG. 19. In addition, the configurations of the gNB-CUs (e.g., gNB-CUs 201, 301, etc.) and gNB-DUs (e.g., gNB-DUs 202, 302, etc.) described in the above example embodiments may also be similar to the configuration shown in FIG. 19.

Referring to FIG. 19, the gNB-CU 10 includes a network interface 1901, a processor 1902, and a memory 1903. The network interface 1901 is used to communicate with network nodes (e.g., gNB-DUs, and control plane (CP) nodes and/or user plane (UP) nodes in the core network). The network interface 1901 may include a plurality of interfaces. The network interface 1901 may include, for example, a fiber optic interface for communication between the CU and DUs and a network interface compliant with the IEEE 802.3 series.

The processor 1902 may include a plurality of processors. If the gNB-CU 10 is a gNB-CU-CP, the processor 1902 performs control plane processing, such as processing related to NGAP, RRC, E1AP, and F1AP signaling. If the gNB-CU 10 includes a gNB-CU-UP, the processor 1902 performs, for example, NG-U interface termination, F1-U interface termination, and data processing for the SDAP and PDCP layers.

In the case of the gNB-DUs 21 and 22, the processor 1902 performs digital baseband signal processing (data plane processing) and control plane processing for wireless communications. For example, the processor 1902 may include a modem processor (e.g., a Digital Signal Processor (DSP)) that performs digital baseband signal processing and a protocol stack processor (e.g., a Central Processing Unit (CPU) or a Micro Processing Unit (MPU)) that performs control plane processing. The digital baseband signal processing may include signal processing for the RLC, MAC, and PHY layers. The control plane processing may include processing of MAC CEs and DCIs. The processor 1902 may include a digital beamformer module for beamforming. The digital beamformer module may include a MIMO encoder and precoder.

The memory 1903 is composed of a combination of volatile and non-volatile memory. The volatile memory is, for example, Static Random Access Memory (SRAM), Dynamic RAM (DRAM), or a combination thereof. The non-volatile memory is Mask Read Only Memory (MROM), Electrically Erasable Programmable ROM (EEPROM), flash memory, hard disk drive, or any combination thereof. The memory 1903 may include storage that is remote from the processor 1902. In this case, the processor 1902 may access the memory 1903 through the network interface 1901 or an I/O interface not shown.

The memory 1903 may store one or more software modules (or computer programs) 1904 containing a set of instructions and data for processing by the gNB-CU 10 described in the plurality of embodiments described above. In some implementations, the processor 1902 may be configured to read and execute the one or more software modules 1904 from the memory 1903, thereby performing the processing of the gNB-CU 10 described in the example embodiments described above.

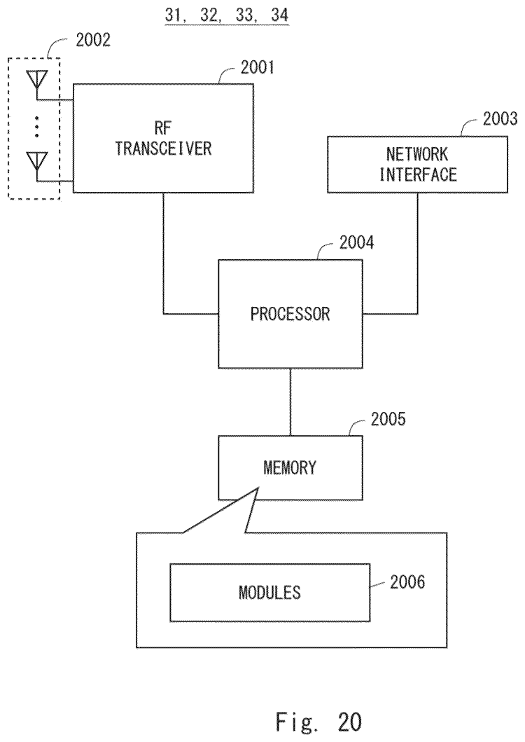

FIG. 20 is a block diagram showing an example configuration of the TRPs 31 to 34. The configuration of the TRPs (e.g., TRPs 703, 704, etc.) described in the example embodiments above may be similar to the configuration shown in FIG. 20. Referring to FIG. 20, each of the TRPs 31 to 34 includes an RF transceiver 2001, a network interface 2003, a processor 2004, and a memory 2005. The RF transceiver 2001 performs analog RF signal processing to communicate with the UEs. The RF transceiver 2001 may include a plurality of transceivers. The RF transceiver 2001 is coupled to an antenna array 2002 and the processor 2004. The RF transceiver 2001 receives modulated symbol data from the processor 2004, generates a transmission RF signal, and supplies the transmission RF signal to the antenna array 2002. The RF transceiver 2001 generates a baseband reception signal based on a reception RF signal received by the antenna array 2002 and supplies the baseband reception signal to the processor 2004. The RF transceiver 2001 may include an analog beamformer circuit for beamforming. The analog beamformer circuit includes, for example, a plurality of phase shifters and a plurality of power amplifiers.

The network interface 2003 is used to communicate with network nodes (e.g., gNB-DUs, other TRPs). The network interface 2003 may include a plurality of interfaces. The network interface 2003 may include, for example, a fiber optic interface for communication between a DU and a TRP (and between TRPs) and a network interface compliant with the IEEE 802.3 series.

The processor 2004 may include one or more processors. The processor 2004 may include a DFE and a controller. The DFE provides low PHY layer signal processing and digital radio signal processing.

The memory 2005 is composed of a combination of volatile and non-volatile memory. The volatile memory is, for example, SRAM, DRAM, or a combination thereof. The non-volatile memory is MROM, EEPROM, flash memory, hard disk drive, or any combination thereof. The memory 2005 may include storage that is remote from the processor 2004. In this case, the processor 2004 may access the memory 2005 through the network interface 2003 or an I/O interface not shown.

The memory 2005 may store one or more software modules (or computer programs) 2006 containing a set of instructions and data for performing at least a portion of the processing by the TRPs 31 to 34 described in the example embodiments described above. In some implementations, the processor 2004 may be configured to read and execute the software module 2006 from the memory 2005, thereby performing at least a portion of the processing of the TRPs 31 to 34 described in the example embodiments described above.

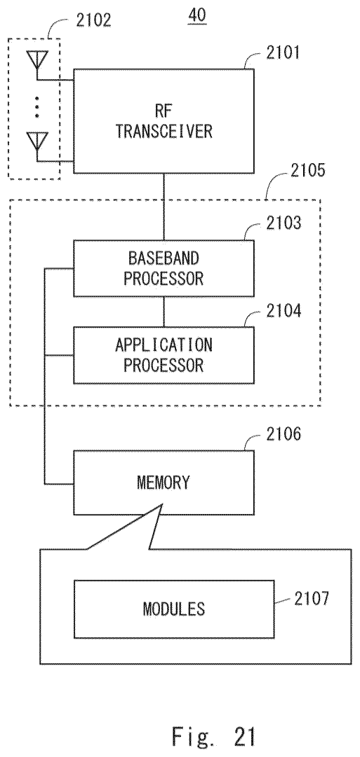

FIG. 21 is a block diagram showing an example configuration of the UE 40. The configuration of the UEs (e.g., UE 705, 806, etc.) described in the above example embodiments may be similar to the configuration shown in FIG. 21.

The RF transceiver 2101 performs analog RF signal processing to communicate with the TRPs. The RF transceiver 2101 may include a plurality of transceivers. The analog RF signal processing performed by the RF transceiver 2101 includes frequency up-conversion, frequency down-conversion, and amplification. The RF transceiver 2101 is coupled with an antenna array 2102 and a baseband processor 2103. The RF transceiver 2101 receives modulated symbol data (or OFDM symbol data) from the baseband processor 2103, generates a transmission RF signal, and supplies the transmission RF signal to the antenna array 2102. The RF transceiver 2101 also generates a baseband received signal based on a received RF signal received by the antenna array 2102, and supplies the baseband received signal to the baseband processor 2103. The RF transceiver 2101 may include an analog beamformer circuit for beamforming. The analog beamformer circuit includes, for example, multiple phase shifters and multiple power amplifiers.

The baseband processor 2103 performs digital baseband signal processing (data-plane processing) and control-plane processing for wireless communication. The digital baseband signal processing includes (a) data compression/decompression, (b) data segmentation/concatenation, (c) transmission format (transmission frame) composition/decomposition, (d) channel encoding/decoding, (e) modulation (i.e., symbol mapping)/demodulation, and (f) generation of OFDM symbol data (baseband OFDM signal) using Inverse Fast Fourier Transform (IFFT) and so on. On the other hand, the control-plane processing includes communication management of layer 1 (e.g., transmission power control), layer 2 (e.g., radio resource management, and hybrid automatic repeat request (HARQ) processing), and layer 3 (e.g., signaling related to attach, mobility, and call management).

For example, the digital baseband signal processing performed by the baseband processor 2103 may include signal processing for the SDAP, PDCP, RLC, MAC, and PHY layers. The control plane processing by the baseband processor 2103 may include processing of Non-Access Stratum (NAS) protocols, RRC protocols, MAC CEs, and DCIs.

The baseband processor 2103 may perform MIMO encoding and precoding for beamforming.

The baseband processor 2103 may include a modem processor (e.g., DSP) that performs digital baseband signal processing and a protocol stack processor (e.g., CPU or MPU) that performs control plane processing. In this case, the protocol stack processor that performs control plane processing may be integrated with an application processor 2104 described later.

The application processor 2104 is also referred to as a CPU, MPU, microprocessor, or processor core. The application processor 2104 may include a plurality of processors (a plurality of processor cores). The application processor 2104 executes system software programs (operating system (OS)) and various application programs (e.g., voice call application, web browser, mailer, camera control application, music player application) read from a memory 2106 or other memory not shown, thereby realizing various functions of the UE 40.

In some implementations, as shown by the dashed line (2105) in FIG. 22, the baseband processor 2103 and the application processor 2104 may be integrated on a single chip. In other words, the baseband processor 2103 and the application processor 2104 may be implemented as a single System on Chip (SoC) device 2105. The SoC device may also be referred to as a system large-scale integration (LSI) or chipset.

The memory 2106 is a volatile memory, a non-volatile memory, or a combination thereof. The memory 2106 may include a plurality of physically independent memory devices. The volatile memory is, for example, SRAM, DRAM, or a combination thereof. The non-volatile memory is, for example, MROM, EEPROM, flash memory, or a hard disk drive, or any combination thereof. For example, the memory 2106 may include an external memory device that is accessible by the baseband processor 2103, the application processor 2104, and the SoC 2105. The memory 2106 may include an internal memory device that is integrated into the baseband processor 2103, the application processor 2104, or the SoC 2105. In addition, the memory 2106 may include memory within a Universal Integrated Circuit Card (UICC).

The memory 2106 may store one or more software modules (or computer programs) 2107 that include a set of instructions and data for performing the processing by the radio terminal 3 described in the above example embodiments. In some implementations, the baseband processor 2103 or the application processor 2104 may be configured to read and execute the software modules 2107 from the memory 2106, thereby performing the processing of the UE 40 as described in the example embodiments with reference to the drawings.

The control plane processing and operations performed by the UE 40 described in the above example embodiment can be implemented by elements other than the RF transceiver 2101 and the antenna array 2102, namely at least one of the baseband processor 2103 and the application processor 2104, and the memory 2106 that stores the software modules 2107.

As described using FIGS. 21 and 22, each of the processors in the gNB-CUs, gNB-DUs, TRPs, and UEs according to the example embodiments described above can execute one or more programs, containing a set of instructions, to cause a computer to perform an algorithm described with reference to the drawings. Each of these programs contains a set of instructions (or software codes) that, when loaded into a computer, causes the computer to perform one or more of the functions described in the example embodiments. Each of these programs may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disk (DVD), Blu-ray (registered trademark) disc or other optical disk storage, magnetic cassettes, magnetic tape, magnetic disk storage or other magnetic storage devices. Each program may be transmitted on a transitory computer readable medium or a communication medium. By way of example, and not limitation, transitory computer readable media or communication media can include electrical, optical, acoustic, or other form of propagated signals.

The example embodiments described above are merely examples of applications of the technical ideas of the inventors. These technical ideas are not limited to the above-described example embodiments, and various modifications may be made thereto.

For example, the whole or part of the example embodiments disclosed above can be described as, but not limited to, the following supplementary notes.

### Supplementary Note 1

A central unit (CU) of a radio access network node, comprising:
at least one memory; and
at least one processor coupled to the at least one memory and configured to:
   receive from a first distributed unit (DU) of the radio access network node a first message related to preparation for L1/L2-based inter-cell mobility of a User Equipment (UE), wherein the L1/L2-based inter-cell mobility is intra-DU L1/L2-based inter-cell mobility within the first DU or inter-DU L1/L2-based inter-cell mobility from the first DU to a second DU; and
   after receiving the first message, send to the first DU a second message related to the preparation for the L1/L2-based inter-cell mobility.

### Supplementary Note 2

The CU according to Supplementary Note 1, wherein the second message allows or requests the first DU to determine execution of the L1/L2-based inter-cell mobility.

### Supplementary Note 3

The CU according to Supplementary Note 1, wherein the second message allows or requests the first DU to provide the CU with information necessary for the CU to determine execution of the L1/L2-based inter-cell mobility.

### Supplementary Note 4

The CU according to Supplementary Note 1, wherein the second message includes a configuration of one or more target cells.

### Supplementary Note 5

The CU according to Supplementary Note 1, wherein the second message comprises a Radio Resource Control (RRC) message,
wherein the RRC message includes a configuration of one or more target cells.

### Supplementary Note 6

The CU according to any one of Supplementary Notes 1 to 5, wherein the first message requests the CU to prepare the L1/L2-based inter-cell mobility.

### Supplementary Note 7

The CU according to any one of Supplementary Notes 1 to 5, wherein
the first message indicates one or more candidate target cells for the L1/L2-based inter-cell mobility, and
the at least one processor is configured to include in the second message a configuration of at least one target cell selected from the one or more candidate target cells.

### Supplementary Note 8

The CU according to any one of Supplementary Notes 1 to 5, wherein
the first message indicates one or more candidate target cells for the L1/L2-based inter-cell mobility, and
the at least one processor is configured to:
   send to the second DU a third message indicating the one or more candidate target cells;
   receive from the second DU a fourth message including information about at least one prepared target cell; and
   include in the second message a configuration of the at least one prepared target cell.

### Supplementary Note 9

A method performed by a central unit (CU) of a radio access network node, the method comprising:
receiving from a first distributed unit (DU) of the radio access network node a first message related to preparation for L1/L2-based inter-cell mobility of a User Equipment (UE), wherein the L1/L2-based inter-cell mobility is intra-DU L1/L2-based inter-cell mobility within the first DU or inter-DU L1/L2-based inter-cell mobility from the first DU to a second DU; and
after receiving the first message, sending to the first DU a second message related to the preparation for the L1/L2-based inter-cell mobility.

### Supplementary Note 10

A program for causing a computer to perform a method for a central unit (CU) of a radio access network node, the method comprising:
receiving from a first distributed unit (DU) of the radio access network node a first message related to preparation for L1/L2-based inter-cell mobility of a User Equipment (UE), wherein the L1/L2-based inter-cell mobility is intra-DU L1/L2-based inter-cell mobility within the first DU or inter-DU L1/L2-based inter-cell mobility from the first DU to a second DU; and
after receiving the first message, sending to the first DU a second message related to the preparation for the L1/L2-based inter-cell mobility.

### Supplementary Note 11

A first distributed unit (DU) of a radio access network node, comprising:
at least one memory; and
at least one processor coupled to the at least one memory and configured to:
   send to a central unit (CU) of the radio access network node a first message related to preparation for L1/L2-based inter-cell mobility of a User Equipment (UE), wherein the L1/L2-based inter-cell mobility is intra-DU L1/L2-based inter-cell mobility within the first DU or inter-DU L1/L2-based inter-cell mobility from the first DU to a second DU; and
   after sending the first message, receive from the CU a second message related to the preparation for the L1/L2-based inter-cell mobility.

### Supplementary Note 12

The first DU according to Supplementary Note 11, wherein the second message allows or requests the first DU to determine execution of the L1/L2-based inter-cell mobility.

### Supplementary Note 13

The first DU according to Supplementary Note 11, wherein the second message allows or requests the first DU to provide the CU with information necessary for the CU to determine execution of the L1/L2-based inter-cell mobility.

### Supplementary Note 14

The first DU according to Supplementary Note 11, wherein the second message includes a configuration of one or more target cells.

### Supplementary Note 15

The first DU according to Supplementary Note 11, wherein the second message comprises a Radio Resource Control (RRC) message,
wherein the RRC message includes a configuration of one or more target cells.

### Supplementary Note 16

The first DU according to any one of Supplementary Notes 11 to 15, wherein the first message requests the CU to prepare the L1/L2-based inter-cell mobility.

### Supplementary Note 17

The first DU according to any one of Supplementary Notes 11 to 15, wherein
the first message indicates one or more candidate target cells for the L1/L2-based inter-cell mobility, and
the second message includes a configuration of at least one target cell selected by the CU or the second DU from the one or more candidate target cells.

### Supplementary Note 18

A method performed by a first distributed unit (DU) of a radio access network node, the method comprising:
sending to a central unit (CU) of the radio access network node a first message related to preparation for L1/L2-based inter-cell mobility of a User Equipment (UE), wherein the L1/L2-based inter-cell mobility is intra-DU L1/L2-based inter-cell mobility within the first DU or inter-DU L1/L2-based inter-cell mobility from the first DU to a second DU; and
after sending the first message, receiving from the CU a second message related to the preparation for the L1/L2-based inter-cell mobility.

### Supplementary Note 19

A program for causing a computer to perform a method for a first distributed unit (DU) of a radio access network node, the method comprising:
sending to a central unit (CU) of the radio access network node a first message related to preparation for L1/L2-based inter-cell mobility of a User Equipment (UE), wherein the L1/L2-based inter-cell mobility is intra-DU L1/L2-based inter-cell mobility within the first DU or inter-DU L1/L2-based inter-cell mobility from the first DU to a second DU; and
after sending the first message, receiving from the CU a second message related to the preparation for the L1/L2-based inter-cell mobility.

### Supplementary Note 20

A second distributed unit (DU) of a radio access network node, comprising:
at least one memory; and
at least one processor coupled to the at least one memory and configured to:
   receive from a central unit (CU) of the radio access network node a third message related to preparation for L1/L2-based inter-cell mobility of a User Equipment (UE), wherein the L1/L2-based inter-cell mobility is inter-DU L1/L2-based inter-cell mobility from a first DU to the second DU; and
   after receiving the third message, send to the CU a fourth message related to the preparation for the L1/L2-based inter-cell mobility.

### Supplementary Note 21

The second DU according to Supplementary Note 20, wherein the third message allows or requests the second DU to determine execution of the L1/L2-based inter-cell mobility.

### Supplementary Note 22

The second DU according to Supplementary Note 20, wherein the third message allows or requests the second DU to provide the CU with information necessary for the CU to determine execution of the L1/L2-based inter-cell mobility.

### Supplementary Note 23

The second DU according to Supplementary Note 20, wherein the third message requests the second DU to prepare the L1/L2-based inter-cell mobility.

### Supplementary Note 24

The second DU according to any one of Supplementary Notes 20 to 23, wherein
the third message indicates one or more candidate target cells for the L1/L2-based inter-cell mobility, and
the at least one processor is configured to include in the fourth message a configuration of at least one target cell selected from the one or more candidate target cells.

### Supplementary Note 25

A method performed by a second distributed unit (DU) of a radio access network node, the method comprising:
receiving from a central unit (CU) of the radio access network node a third message related to preparation for L1/L2-based inter-cell mobility of a User Equipment (UE), wherein the L1/L2-based inter-cell mobility is inter-DU L1/L2-based inter-cell mobility from a first DU to the second DU; and
after receiving the third message, sending to the CU a fourth message related to the preparation for the L1/L2-based inter-cell mobility.

### Supplementary Note 26

A program for causing a computer to perform a method for a second distributed unit (DU) of a radio access network node, the method comprising:
receiving from a central unit (CU) of the radio access network node a third message related to preparation for L1/L2-based inter-cell mobility of a User Equipment (UE), wherein the L1/L2-based inter-cell mobility is inter-DU L1/L2-based inter-cell mobility from a first DU to the second DU; and
after receiving the third message, sending to the CU a fourth message related to the preparation for the L1/L2-based inter-cell mobility.

### Supplementary Note 27

A radio access network node comprising:
at least one memory; and
at least one processor coupled to the at least one memory and configured to:
   communicate with a User Equipment (UE) via a source Transmission Reception Point (TRP) serving a source cell; and
   during or prior to execution of L1/L2-based inter-cell mobility for changing a serving cell of the UE from the source cell to a target cell provided by a target TRP, perform a multi-TRP operation between the source TRP and the target TRP, wherein
the L1/L2-based inter-cell mobility is intra-DU L1/L2-based inter-cell mobility within a first distributed unit (DU) or inter-DU L1/L2-based inter-cell mobility from the first DU to a second DU.

### Supplementary Note 28

The radio access network node according to Supplementary Note 27, wherein the radio access network node comprises one or both of the first DU and a central unit (CU).

### Supplementary Note 29

The radio access network node according to Supplementary Note 27 or 28, wherein the at least one processor is configured to transmit information required for the multi-TRP operation to the UE.

### Supplementary Note 30

The radio access network node according to Supplementary Note 29, wherein the at least one processor is configured to transmit the information required for the multi-TRP operation to the UE during a preparation phase of the L1/L2-based inter-cell mobility.

### Supplementary Note 31

The radio access network node according to Supplementary Note 30, wherein the preparation phase comprises providing the UE with a Radio Resource Control (RRC) configuration related to the target cell.

### Supplementary Note 32

The radio access network node according to any one of Supplementary Notes 27 to 31, wherein
the source TRP and the target TRP belong to the first DU and the second DU, respectively, and
the at least one processor is configured to share a configuration related to the multi-TRP operation with the second DU.

### Supplementary Note 33

The radio access network node according to Supplementary Note 32, wherein the configuration related to the multi-TRP operation includes a configuration of a Transmission Configuration Indicator (TCI) state.

### Supplementary Note 34

The radio access network node according to Supplementary Note 32 or 33, wherein the at least one processor is configured to receive the configuration related to the multi-TRP operation from the second DU during or after the L1/L2-based inter-cell mobility is prepared.

### Supplementary Note 35

The radio access network node according to any one of Supplementary Notes 27 to 34, wherein the at least one processor is configured to instruct the UE to change the serving cell from the source cell to the target cell during the multi-TRP operation being performed.

### Supplementary Note 36

The radio access network node according to any one of Supplementary Notes 27 to 35, wherein the multi-TRP operation comprises a non-coherent joint transmission from the source TRP and the target TRP.

### Supplementary Note 37

A method performed by a radio access network node, the method comprising:
communicating with a User Equipment (UE) via a source Transmission Reception Point (TRP) serving a source cell; and
during or prior to execution of L1/L2-based inter-cell mobility for changing a serving cell of the UE from the source cell to a target cell provided by a target TRP, performing a multi-TRP operation between the source TRP and the target TRP, wherein
the L1/L2-based inter-cell mobility is intra-DU L1/L2-based inter-cell mobility within a first distributed unit (DU) or inter-DU L1/L2-based inter-cell mobility from the first DU to a second DU.

### Supplementary Note 38

A program for causing a computer to perform a method for a radio access network node, the method comprising:
communicating with a User Equipment (UE) via a source Transmission Reception Point (TRP) serving a source cell; and
during or prior to execution of L1/L2-based inter-cell mobility for changing a serving cell of the UE from the source cell to a target cell provided by a target TRP, performing a multi-TRP operation between the source TRP and the target TRP, wherein
the L1/L2-based inter-cell mobility is intra-DU L1/L2-based inter-cell mobility within a first distributed unit (DU) or inter-DU L1/L2-based inter-cell mobility from the first DU to a second DU.

### Supplementary Note 39

A second distributed unit (DU) of a radio access network node, comprising:
at least one memory; and
at least one processor coupled to the at least one memory and configured to:
   during or prior to execution of inter-DU L1/L2-based inter-cell mobility from a source cell associated with a first DU to a target cell associated with the second DU, control a target Transmission Reception Point (TRP) to perform a multi-TRP operation between a source TRP serving the serving cell and the target TRP serving the target cell.

### Supplementary Note 40

The second DU according to Supplementary Note 39, wherein the at least one processor is configured to share a configuration related to the multi-TRP operation with the first DU during or after the L1/L2-based inter-cell mobility is prepared.

### Supplementary Note 41

The second DU according to Supplementary Note 40, wherein the configuration related to the multi-TRP operation includes a configuration of a Transmission Configuration Indicator (TCI) state.

### Supplementary Note 42

The second DU according to Supplementary Note 40 or 41, wherein the at least one processor is configured to send the configuration related to the multi-TRP operation to the first DU directly or via a central unit (CU).

### Supplementary Note 43

The second DU according to any one of Supplementary Notes 39 to 42, wherein the at least one processor is configured to instruct the UE to change the serving cell from the source cell to the target cell during the multi-TRP operation being performed.

### Supplementary Note 44

The second DU according to any one of Supplementary Notes 39 to 43, wherein the at least one processor is configured to detect an access of the UE to change the serving cell of the UE to the target cell while the multi TRP operation is being performed.

### Supplementary Note 45

The second DU according to any one of Supplementary Notes 39 to 44, wherein the multi-TRP operation comprises a non-coherent joint transmission from the source TRP and the target TRP.

### Supplementary Note 46

A method performed by a second distributed unit (DU) of a radio access network node, the method comprising:
during or prior to execution of inter-DU L1/L2-based inter-cell mobility from a source cell associated with a first DU to a target cell associated with the second DU, controlling a target Transmission Reception Point (TRP) to perform a multi-TRP operation between a source TRP serving the serving cell and the target TRP serving the target cell.

### Supplementary Note 47

A program for causing a computer to perform a method for a second distributed unit (DU) of a radio access network node, the method comprising:
during or prior to execution of inter-DU L1/L2-based inter-cell mobility from a source cell associated with a first DU to a target cell associated with the second DU, controlling a target Transmission Reception Point (TRP) to perform a multi-TRP operation between a source TRP serving the serving cell and the target TRP serving the target cell.

### Supplementary Note 48

A User Equipment (UE) comprising:
at least one memory; and
at least one processor coupled to the at least one memory and configured to:
   communicate with a first Distributed Unit (DU) via a source Transmission Reception Point (TRP) serving a source cell; and
   during or prior to execution of L1/L2-based inter-cell mobility for changing a serving cell of the UE from the source cell to a target cell provided by a target TRP, perform a multi-TRP operation between the source TRP and the target TRP, wherein
the L1/L2-based inter-cell mobility is intra-DU L1/L2-based inter-cell mobility within the first DU or inter-DU L1/L2-based inter-cell mobility from the first DU to a second DU.

### Supplementary Note 49

The UE according to Supplementary Note 48, wherein the at least one processor is configured to receive information required for the multi-TRP operation from the first DU or from a central unit (CU) via the first DU.

### Supplementary Note 50

The UE according to Supplementary Note 49, wherein the at least one processor is configured to receive information required for the multi-TRP operation during a preparation phase of the L1/L2-based inter-cell mobility.

### Supplementary Note 51

The UE according to Supplementary Note 50, wherein the preparation phase comprises providing a Radio Resource Control (RRC) configuration related to the target cell from the CU to the UE.

### Supplementary Note 52

The UE according to any one of Supplementary Notes 48 to 51, wherein the at least one processor is configured to change the serving cell from the source cell to the target cell during the multi-TRP operation being performed.

### Supplementary Note 53

The UE according to any one of Supplementary Notes 48 to 52, wherein the at least one processor is configured to receive an instruction from the second DU associated with the target cell to change the serving cell from the source cell to the target cell during the multi-TRP operation being performed.

### Supplementary Note 54

The UE according to any one of Supplementary Notes 48 to 53, wherein the multi-TRP operation comprises a non-coherent joint transmission from the source TRP and the target TRP.

### Supplementary Note 55

A method performed by a User Equipment (UE), the method comprising:
communicating with a first Distributed Unit (DU) via a source Transmission Reception Point (TRP) serving a source cell; and
during or prior to execution of L1/L2-based inter-cell mobility for changing a serving cell of the UE from the source cell to a target cell provided by a target TRP, performing a multi-TRP operation between the source TRP and the target TRP, wherein
the L1/L2-based inter-cell mobility is intra-DU L1/L2-based inter-cell mobility within the first DU or inter-DU L1/L2-based inter-cell mobility from the first DU to a second DU.

### Supplementary Note 56

A program for causing a computer to perform a method for a User Equipment (UE), the method comprising:
communicating with a first Distributed Unit (DU) via a source Transmission Reception Point (TRP) serving a source cell; and
during or prior to execution of L1/L2-based inter-cell mobility for changing a serving cell of the UE from the source cell to a target cell provided by a target TRP, performing a multi-TRP operation between the source TRP and the target TRP, wherein
the L1/L2-based inter-cell mobility is intra-DU L1/L2-based inter-cell mobility within the first DU or inter-DU L1/L2-based inter-cell mobility from the first DU to a second DU.

### Supplementary Note 57

A second distributed unit (DU) of a radio access network node, comprising:
at least one memory; and
at least one processor coupled to the at least one memory and configured to:
   receive from a central unit (CU) or a first DU of the radio access network node a first message related to preparation for L1/L2-based inter-cell mobility of a User Equipment (UE), wherein the L1/L2-based inter-cell mobility is inter-DU L1/L2-based inter-cell mobility from a source cell associated with the first DU to a target cell associated with the second DU; and
   in response to an access from the UE to the target cell, notify the CU or the first DU of a detection or completion of the L1/L2-based inter-cell mobility.

### Supplementary Note 58

The second DU according to Supplementary Note 57, wherein
the first message indicates that the second DU is requested or permitted to transmit an instruction for the L1/L2-based inter-cell mobility to the UE, and
the at least one processor is configured to transmit the instruction for the L1/L2-based inter-cell mobility to the UE in response to receiving the first message.

### Supplementary Note 59

The second DU according to Supplementary Note 57 or 58, wherein the at least one processor is configured to send a second message indicating information about the target cell to the CU or the first DU in response to receiving the first message.

### Supplementary Note 60

The second DU according to Supplementary Note 59,
the first message indicates one or more candidate target cells for the L1/L2-based inter-cell mobility, and
the at least one processor is configured to include, in the second message, information about at least one target cell selected from the one or more candidate target cells.

### Supplementary Note 61

A method performed by a second distributed unit (DU) of a radio access network node, the method comprising:
receiving from a central unit (CU) or a first DU of the radio access network node a first message related to preparation for L1/L2-based inter-cell mobility of a User Equipment (UE), wherein the L1/L2-based inter-cell mobility is inter-DU L1/L2-based inter-cell mobility from a source cell associated with the first DU to a target cell associated with the second DU; and
in response to an access from the UE to the target cell, notifying the CU or the first DU of a detection or completion of the L1/L2-based inter-cell mobility.

### Supplementary Note 62

A program for causing a computer to perform a method for a second distributed unit (DU) of a radio access network node, the method comprising:
receiving from a central unit (CU) or a first DU of the radio access network node a first message related to preparation for L1/L2-based inter-cell mobility of a User Equipment (UE), wherein the L1/L2-based inter-cell mobility is inter-DU L1/L2-based inter-cell mobility from a source cell associated with the first DU to a target cell associated with the second DU; and
in response to an access from the UE to the target cell, notifying the CU or the first DU of a detection or completion of the L1/L2-based inter-cell mobility.

### Supplementary Note 63

A User Equipment (UE) comprising:
at least one memory; and
at least one processor coupled to the at least one memory and configured to provide a Radio Resource Control (RRC) layer and lower layers including a Medium Access Control (MAC) layer and a Physical (PHY) layer, wherein
the lower layers are configured to perform a random access procedure to a target cell for L1/L2-based inter-cell mobility, and to notify the RRC layer of completion of the L1/L2-based inter-cell mobility after completion of the random access procedure, and
the L1/L2-based inter-cell mobility is intra-distributed unit (DU) L1/L2-based inter-cell mobility within a first DU or inter-DU L1/L2-based inter-cell mobility from the first DU to a second DU.

### Supplementary Note 64

The UE according to Supplementary Note 63, wherein the RRC layer is configured to generate an RRC Reconfiguration Complete message in response to the RRC layer being notified of the completion of the L1/L2-based inter-cell mobility, and to request the lower layers to send the RRC Reconfiguration Complete message.

### Supplementary Note 65

The UE according to Supplementary Note 63 or 64, wherein the lower layers are configured to send control information indicating a failure of the random access procedure to the second DU or the first DU if the random access procedure has failed.

### Supplementary Note 66

The UE according to Supplementary Note 65, wherein the lower layers are configured to send the control information using a MAC Control Element.

### Supplementary Note 67

The UE according to Supplementary Note 65 or 66, wherein the control information indicates a failure of the L1/L2-based inter-cell mobility.

### Supplementary Note 68

The UE according to Supplementary Note 65 or 66, wherein the control information indicates a beam failure.

### Supplementary Note 69

The UE according to any one of Supplementary Notes 63 to 68, wherein the lower layers are configured to perform the random access procedure in response to an execution condition for the L1/L2-based inter-cell mobility being satisfied.

### Supplementary Note 70

The UE according to any one of Supplementary Notes 63 to 68, wherein the lower layers are configured to perform the random access procedure in response to receiving from the first DU or the second DU a Layer-1 or Layer-2 signaling indicating an instruction to perform the L1/L2-based inter-cell mobility.

### Supplementary Note 71

A method performed by a User Equipment (UE), the method comprising:
providing a Radio Resource Control (RRC) layer and lower layers including a Medium Access Control (MAC) layer and a Physical (PHY) layer;
performing, by the lower layers, a random access procedure to a target cell for L1/L2-based inter-cell mobility; and
notifying, by the lower layers, the RRC layer of completion of the L1/L2-based inter-cell mobility after completion of the random access procedure, wherein
the L1/L2-based inter-cell mobility is intra-distributed unit (DU) L1/L2-based inter-cell mobility within a first DU or inter-DU L1/L2-based inter-cell mobility from the first DU to a second DU.

### Supplementary Note 72

A program for causing a computer to perform a method for a User Equipment (UE), the method comprising:
providing a Radio Resource Control (RRC) layer and lower layers including a Medium Access Control (MAC) layer and a Physical (PHY) layer;
performing, by the lower layers, a random access procedure to a target cell for L1/L2-based inter-cell mobility; and
notifying, by the lower layers, the RRC layer of completion of the L1/L2-based inter-cell mobility after completion of the random access procedure, wherein
the L1/L2-based inter-cell mobility is intra-distributed unit (DU) L1/L2-based inter-cell mobility within a first DU or inter-DU L1/L2-based inter-cell mobility from the first DU to a second DU.

### Supplementary Note 73

A User Equipment (UE) comprising:
at least one memory; and
at least one processor coupled to the at least one memory and configured to provide a Radio Resource Control (RRC) layer and lower layers including a Medium Access Control (MAC) layer and a Physical (PHY) layer, wherein
the lower layers are configured to perform a random access procedure to a target cell for L1/L2-based inter-cell mobility after notifying the RRC layer of execution of the L1/L2-based inter-cell mobility, and
the L1/L2-based inter-cell mobility is intra-distributed unit (DU) L1/L2-based inter-cell mobility within a first DU or inter-DU L1/L2-based inter-cell mobility from the first DU to a second DU.

### Supplementary Note 74

The UE according to Supplementary Note 73, wherein the RRC layer is configured to generate an RRC Reconfiguration Complete message in response to the RRC layer being notified of the execution of the L1/L2-based inter-cell mobility, and to request the lower layers to send the RRC Reconfiguration Complete message.

### Supplementary Note 75

The UE according to Supplementary Note 74, wherein the lower layers are configured to notify the RRC layer of completion of the L1/L2-based inter-cell mobility if the random access procedure and the transmission of the RRC Reconfiguration Complete message are completed.

### Supplementary Note 76

The UE according to any one of Supplementary Notes 73 to 75, wherein the lower layers are configured to notify the RRC layer of a failure of the random access procedure if the random access procedure has failed.

### Supplementary Note 77

The UE according to Supplementary Note 76, wherein the notification of the failure of the random access procedure indicates a failure of the L1/L2-based inter-cell mobility.

### Supplementary Note 78

The UE according to Supplementary Note 76 or 77, wherein the RRC layer is configured to discard a generated RRC Reconfiguration Complete message in response to being notified of the failure of the random access procedure.

### Supplementary Note 79

The UE according to any one of Supplementary Notes 76 to 78, wherein the lower layers are configured to send control information indicating a failure of the random access procedure to the second DU or the first DU.

### Supplementary Note 80

The UE according to Supplementary Note 79, wherein the lower layers are configured to send the control information using a MAC Control Element.

### Supplementary Note 81

The UE according to Supplementary Note 79 or 80, wherein the control information indicates a failure of the L1/L2-based inter-cell mobility.

### Supplementary Note 82

The UE according to Supplementary Note 79 or 80, wherein the control information indicates a beam failure.

### Supplementary Note 83

The UE according to any one of Supplementary Notes 73 to 82, wherein the lower layers are configured to, in response to an execution condition for the L1/L2-based inter-cell mobility being satisfied, notify the RRC layer of the execution of the L1/L2-based inter-cell mobility and perform the random access procedure.

### Supplementary Note 84

The UE according to any one of Supplementary Notes 73 to 82, wherein the lower layers are configured to, in response to receiving from the first DU or the second DU a Layer-1 or Layer-2 signaling indicating an instruction to perform the L1/L2-based inter-cell mobility, notify the RRC layer of the execution of the L1/L2-based inter-cell mobility and perform the random access procedure.

### Supplementary Note 85

A method performed by a User Equipment (UE), the method comprising:
providing a Radio Resource Control (RRC) layer and lower layers including a Medium Access Control (MAC) layer and a Physical (PHY) layer; and
performing, by the lower layers, a random access procedure to a target cell for L1/L2-based inter-cell mobility after notifying the RRC layer of execution of the L1/L2-based inter-cell mobility.

### Supplementary Note 86

A program for causing a computer to perform a method for a User Equipment (UE), the method comprising:
providing a Radio Resource Control (RRC) layer and lower layers including a Medium Access Control (MAC) layer and a Physical (PHY) layer; and
performing, by the lower layers, a random access procedure to a target cell for L1/L2-based inter-cell mobility after notifying the RRC layer of execution of the L1/L2-based inter-cell mobility.

This application is based upon and claims the benefit of priority from Japanese Patent Application No. 2022-121937, filed on Jul. 29, 2022, the disclosure of which is incorporated herein in its entirety by reference.

### Reference Signs List

10 gNB-CU
21, 22 gNB-DU
31, 32, 33, 34 TRP
40 UE
51, 52, 53, 54 Cell
120 Intra-DU L1/L2-based inter-cell mobility
140 Intra-DU L1/L2-based inter-cell mobility
1902 Processor
1903 Memory
2004 Processor
2005 Memory
2103 Baseband processor
2104 Application processor
2106 Memory

What is claimed is:

1-86. (canceled)

87. A method of a Distributed Unit (DU), the method comprising:
transmitting a Layer-1/Layer-2 triggered Mobility (LTM) execution command in an LTM to a User Equipment (UE); and
after transmitting the execution command, sending a notification of the execution of the LTM to a Central Unit (CU), the notification including information about a target cell.

88. The method according to claim 87, wherein the execution command includes information about the target cell of the LTM and information about a Transmission Configuration Indicator (TCI) state.

89. The method according to claim 87, further comprising:
receiving a UE CONTEXT RELEASE COMMAND message from the CU.

90. A method of a User Equipment (UE), the method comprising:
receiving a Layer-1/Layer-2 triggered Mobility (LTM) execution command in an LTM from a Distributed Unit (DU); and
accessing a target cell.

91. The method according to claim 90, wherein the execution command includes information about the target cell of the LTM and information about a Transmission Configuration Indicator (TCI) state.

92. The method according to claim 90, wherein the access to the target cell is performed by a random access procedure.

93. The method according to claim 90, wherein the LTM is an inter-DU LTM from a source DU to a target DU.

94. A method of a Central Unit (CU), the method comprising:
in a Layer-1/Layer-2 triggered Mobility (LTM), after an LTM execution command is sent to a User Equipment (UE), receiving a first message regarding the execution of the LTM, the first message including information about a target cell; and
after a random access procedure between the UE and the target cell is completed, receiving a third message regarding the execution of the LTM.

95. The method according to claim 94, wherein the execution command includes information about the target cell of the LTM and information about a Transmission Configuration Indicator (TCI) state.

96. The method according to claim 94, further comprising:
sending a UE CONTEXT RELEASE COMMAND message to a Distributed Unit (DU).

97. The method according to claim 94, wherein the LTM is an inter-Distributed Unit (DU) LTM from a source DU to a target DU.

98. A method of a Central Unit (CU), the method comprising:
sending a first message related to a Layer-1/Layer-2 triggered Mobility (LTM) to a first Distributed Unit (DU), the first message including information related to one or more target cells;
receiving a second message, which is a response to the first message, from the first DU, the second message including a configuration of at least one of the one or more target cells; and
sending a third message after receiving the second message.

99. The method according to claim 98, wherein the third message mentioned is a UE CONTEXT MODIFICATION REQUEST message.
